(19) United States
(12) Patent Application Publication
(10) Pub. No.: US 2013/0010579 A1
(43) Pub. Date: Jan. 10, 2013

(54) OPTICAL DISK DEVICE AND SEMICONDUCTOR DEVICE

(75) Inventors: Toshiya MATSUDA, Kanagawa (JP); Mitsunori KOBAYASHI, Chigasaki (JP)

(73) Assignee: RENESAS ELECTRONICS CORPORATION

(21) Appl. No.: 13/543,803

(22) Filed: Jul. 7, 2012

(30) Foreign Application Priority Data
Jul. 8, 2011 (JP) 2011-151530

(51) Int. Cl. G11B 7/095

(52) U.S. Cl. 369/44.11; G9B/7.063

(57) ABSTRACT

An optical disk device is provided in which stable operation is realized even when an offset amount of a signal to be used for servo control changes due to environmental variations. The optical disk device generates a signal for servo control based on signals corresponding to a reflected light of a laser light irradiated to an optical disk, and detects an offset superimposed on a signal for the servo control. The optical disk device compensates the amount of the adjusted offset which has been set up so as to reduce the offset amount in initial setting for light detection corresponding to an optical disk loaded, according to the amount of change of the offset amount detected, adjusts the signal to be used for the servo control based on the amount of the offset control after the compensation, and performs the servo control based on the adjusted signal.

### CROSS-REFERENCE TO RELATED APPLICATIONS

The disclosure of Japanese Patent Application No. 2011-151530 filed on Jul. 8, 2011 including the specification, drawings and abstract is incorporated herein by reference in its entirety.

### BACKGROUND

The present invention relates to an optical disk device which performs record/reproduction of information for an optical disk, and a semiconductor device which controls the optical disk device, and in particular relates to technology which is effective when applied to an optical disk device exhibiting a large amount of change of offset superimposed on a signal used for servo control.

In an optical disk device, when reading data recorded in an optical disk or recording data into the optical disk, focus servo control for controlling laser light irradiated to the optical disk in the focus direction and tracking servo control for controlling the laser light in the radial direction are performed. In the focus servo control, it is mainly determined on the basis of a focus error (FE) signal whether the laser light is being brought into focus correctly on an information storage layer as a target. In the tracking servo control, it is mainly determined on the basis of a tracking error (TE) signal whether the laser light is tracing a track as a target. As related art technology which attains stabilization of the focus servo control and the tracking servo control, Patent Literatures 1 through 3 disclose the technology of adjusting automatically the gain of the focus error signal or the tracking error signal, based on the amount of reflected light from an optical disk.

Patent Literature 1 discloses a method by which the gain of a total optical signal is controlled so that a peak value of the total optical signal becomes equal to a target voltage signal, and that the gain of a focus error signal is also made equal to the gain of the total optical signal. Patent Literature 2 discloses a technology to set the gain of a focus error signal and a tracking error signal, on the basis of a peak value of the total optical signal. Furthermore, Patent Literature 3 discloses a technology to set the gain of a received light signal from each photo detector, on the basis of a peak value of the total optical signal.

(Patent Literature 1) Japanese Patent Laid-open No. Hei 11 (1999)-154336

(Patent Literature 2) Japanese Patent Laid-open No. 2005-50410

(Patent Literature 3) Japanese Patent Laid-open No. 2001-266371

### SUMMARY

As one means for attaining the further cost reduction and the lower power consumption of an optical disk device in recent years, there is reduction of a chip size of a semiconductor device for controlling the optical disk device. In particular, realization of smaller scale of an analog circuit in which chip area reduction effect is large is promoted. For example, the reduction of an element size and the reduction of the number of elements are promoted in an analog circuit which generates a signal used for servo control from an electrical signal generated by a photo detector of an optical pickup. However, as the result of the reduction of an element size and the reduction of the number of elements in an analog circuit, the increase of an offset amount of the analog circuit and the change of the offset amount due to environmental variations such as a change of temperature and a change of power supply voltage have grown too large to ignore. Specifically, the increase of an offset amount and the change of the offset amount due to the environmental variations have an adverse influence on stable operation of the optical disk device. For example, in the case where the gain control of the focus error signal and the tracking error signal is performed on the basis of the peak value of the total optical signal, as disclosed by Patent Literatures 1 through 3, when the amount of the reflected light in the photo detector becomes small, the peak value of the total optical signal also becomes small; accordingly, the gain of the focus error signal, etc. is controlled to be increased. However, if an offset of the analog circuit which generates the total optical signal is large, there is a possibility that the peak value of the total optical signal may become large, even if the amount of the reflected light is small. When the peak value of the total optical signal is large, the servo control will be executed without performing adjustment so as to increase the gain of the focus error signal, etc. Consequently, it is likely that the tracking servo control becomes impracticable for example and data may be recorded on a wrong position, thereby creating an unreproducible optical disk, or it is likely that the focus servo control becomes impracticable and an objective lens may hit an optical disk in a focus search, thereby making scratches on the optical disk. Even if an offset control is performed to reduce an offset amount when an optical disk is mounted, the same issue as described above will arise, if temperature varies and the offset amount changes greatly, in the course of operation of the optical disk device. In particular, an optical disk with a small amount of reflected light like a multilayer BD (Blu-ray Disc: registered trademark) will be easily affected by the offset, because the range of change of an offset amount looks relatively large.

The present invention has been made in view of the above circumstances and provides the technology for enabling stable operation of an optical disk device, even when the offset amount of a signal to be used for servo control changes due to environmental variations.

The above and other purposes and new features will become clear from description of the specification and the accompanying drawings of the present invention.

The following explains briefly an outline of typical inventions to be disclosed by the present application.

That is, an optical disk device generates a signal to be used for servo control on the basis of an analog signal corresponding to an amount of reflected light of a laser light irradiated to an optical disk, and detects an amount of change of an offset amount superimposed on a signal to be used for the servo control. The optical disk device compensates the amount of the offset control which has been set up so as to reduce the offset amount in initial setting for light detection corresponding to an optical disk loaded, according to the amount of change of the offset amount detected, then, the optical disk device adjusts the signal to be used for the servo control on the basis of the amount of the offset control after the compensation. Accordingly, the servo control is performed on the basis of the adjusted signal.

The following explains briefly an effect obtained by the typical inventions to be disclosed in the present application.

That is, according to the present optical disk device, it is possible to attain the stable operation even when the offset amount of a signal to be used for servo control changes due to environmental variations.

### BRIEF DESCRIPTION OF THE DRAWINGS

FIG. 1 is a block diagram illustrating a configuration of the optical disk device according to Embodiment 1;

FIG. 2 is a block diagram illustrating an example of a functional section concerning servo control in a data processing controller 20;

FIG. 3 is an explanatory diagram illustrating an example of a determining method by a focus-servo inability determination circuit 218;

FIG. 4 is an explanatory diagram illustrating an example of changes of a total signal due to environmental variations;

FIG. 5 is a block diagram illustrating an example of a circuit configuration of an offset change amount detecting circuit 207;

FIG. 6 is a flow chart illustrating an example of a flow of reproducing operation (or recording operation) of the optical disk device 1;

FIG. 7 is an explanatory diagram illustrating an example of focus-servo inability determination after the offset control with consideration given to an amount of offset change;

FIG. 8 is a block diagram illustrating a configuration of an optical disk device according to Embodiment 2;

FIG. 9 is an explanatory diagram illustrating another example of changes of a total signal due to environmental variations;

FIG. 10 is a block diagram illustrating an example of a circuit configuration of an offset change amount detecting circuit 237;

FIG. 11 is a flow chart illustrating an example of a flow of reproducing operation (or recording operation) of an optical disk device 5;

FIG. 12 is a block diagram illustrating a configuration of an optical disk device according to Embodiment 3;

FIG. 13 is a block diagram illustrating an example of a functional section concerning servo control in a data processing controller 22;

FIG. 14 is an explanatory diagram illustrating details of a functional section forming a feedback path to an offset circuit 240;

FIG. 15 is a block diagram illustrating a configuration of an optical disk device according to Embodiment 4;

FIG. 16 is a block diagram illustrating an example of a functional section concerning servo control in a data processing controller 23;

FIG. 17 is an explanatory diagram illustrating details of a functional section forming a feedback path to an offset circuit 253; and

FIG. 18 is a timing chart illustrating an example of timing of offset control of electrical signals A-H.

### DETAILED DESCRIPTION

### 1. Outline of Embodiment

First, an outline of a typical embodiment of the invention disclosed in the present application is explained. A numerical symbol of the drawing referred to in parentheses in the outline explanation about the typical embodiment only illustrates what is included in the concept of the component to which the numerical symbol is attached.

(1) (An Optical Disk Device which Performs Offset Control of a Signal to be Used for Servo Control in Consideration of an Offset Change)

An optical disk device (1) for accessing an optical disk (3) according to a typical embodiment of the present invention comprises an optical pickup (10) which irradiates the optical disk with a laser light via an objective lens, condenses the reflected light of the irradiated laser light to a light-sensitive surface of a photo detector (A-H), and generates an analog signal (A-H) corresponding to an amount of the reflected light; and a signal generating unit (204, 205, 206) which generates, on the basis of the analog signal, a signal (a total signal, a focus error signal, and a tracking error signal) to be used for servo control for controlling the optical pickup so as to control a position of a light spot in the optical disk. The optical disk device further comprises an offset change amount detector (207, 237) which detects an amount of change of an offset amount superimposed on the signal to be used for the servo control; a signal shaping unit (208-217) which shapes the signal to be used for the servo control; and a servo control unit (219) which performs the servo control on the basis of the signal shaped by the signal shaping unit. The signal shaping unit (209) compensates an amount of the offset control which has been set up so as to reduce the offset amount in the initial setting for light detection corresponding to an optical disk loaded, according to the amount of change of the offset amount detected, then, the signal shaping unit (209) adjusts the signal to be used for the servo control on the basis of the amount of the offset control after the compensation.

According to the present device, the offset control of the signal to be used for the servo control is performed in consideration of the amount of change of the offset amount; therefore, even when the offset amount changes due to environmental variations, such as temperature and power supply voltage, for example, it becomes possible to perform the stable servo control.

### (2) (A Configuration of the Offset Change Amount Detector (Embodiment 1))

In the optical disk device according to Paragraph 1, the offset change amount detector (207) calculates a difference between a peak value of the signal detected after completing the initial setting and to be used for the servo control and a peak value of a signal to be used for the servo control, then the offset change amount detector (207) sets the difference as the amount of change of the offset amount.

According to the present device, it is possible to easily calculate the amount of change of the offset amount of the signal to be used for the servo control.

### (3) (A Configuration of the Offset Change Amount Detector (Embodiment 2))

In the optical disk device according to Paragraph 1, the offset change amount detector (237) calculates an amount of change of a peak value which indicates how much the peak value of the signal to be used for the servo control has changed after the completion of the initial setting, in consideration of a rate of change of amplitude of the signal to be used for the servo control after the completion of the initial setting, then, the offset change amount detector (237) sets the calculated amount of change of the peak value as the amount of change of the offset amount.

For example, an information storage surface in the neighborhood of the center of an optical disk and an information storage surface in the neighborhood of the outer circumference may differ in the amount of reflected light of a laser light, under the influence of a distortion etc. of the optical disk. In this case, there is a high possibility that the amplitude of a signal to be used for the servo control differs on the inner side of the optical disk and on the outer side. In such an optical disk, since the amplitude of the signal to be used for the servo control is different between the inner side and the outer side of the optical disk, there is a possibility that the peak value of the signal to be used for the servo control seems to have changed, in spite of the fact that the offset amount of the signal to be used for the servo control has not changed. Accordingly, the optical disk device of Paragraph 3 takes into consideration the amount of change of the amplitude as well when calculating the amount of change of the peak value; therefore, it is possible to detect the amount of change of the offset amount with a higher degree of accuracy.
(4) (A Calculation Method of an Amount of Offset Change (Embodiment 2))

In the optical disk device according to Paragraph 3, the offset change amount detector (237) calculates a rate of change of an amplitude value (Vw/Vwref) of the signal to be used for the servo control after the completion of the initial setting, multiplies the rate of change by the peak value (Vpref) of the signal detected after the completion of the initial setting and to be used for the servo control, and the offset change amount detector (237) calculates a difference between the multiplied value and the peak value (Vp) of the signal to be used for the servo control, and sets the difference as the amount of change of the peak value.

According to the present device, it is possible to easily perform the calculation of the amount of change of the offset amount with consideration given to the amount of change of the amplitude.
(5) (A Configuration of the Signal Shaping Unit)

In the optical disk device according to one of Paragraphs 1 through 4, the signal to be used for the servo control includes a total signal corresponding to a summation of the amount of reflected light, a focus error signal for focus servo control, and a tracking error signal for tracking servo control. The offset change amount detector detects the amount of change of the offset amount of the total signal. The signal shaping unit (209, 217, 213, 216) adjusts the total signal through the compensation on the basis of the amount of change of the offset amount of the total signal, and adjusts the magnitude of the focus error signal and the magnitude of the tracking error signal, according to the adjusted total signal.

The total signal also includes the summation of the offset component of plural analog signals generated by plural photo detectors of the optical pickup, for example; accordingly, the total signal will be easily affected by the offset amount of the analog signal compared with the focus error signal, the tracking error signal, etc. Therefore, as described above, if the magnitude (gain) of the focus error signal or the tracking error signal is adjusted on the basis of the magnitude of the total signal, the accuracy of the focus servo control or the tracking servo control will be deteriorated. As preventive measures against the accuracy deterioration of the servo control, it is possible to consider a method in which the amount of change of the offset amount of the focus error signal or the tracking error signal is detected individually and each offset amount is adjusted. However, this method causes increase of the circuit scale of the offset change amount detector. Accordingly, in the optical disk device according to Paragraph 5, the amount of change of the offset amount of the total signal is detected and the offset control of the total signal is performed; then, the magnitude of the focus error signal or the magnitude of the tracking error signal is adjusted on the basis of the adjusted total signal. Accordingly, it is possible to prevent the deterioration of the accuracy of the focus servo control or the tracking servo control, without enlarging the circuit scale of the offset change amount detector.
(6) (An Optical Disk Device which Performs the Offset Control of an Electrical Signal from an Optical Pickup, in Consideration of the Offset Change of the Total Signal (Embodiment 3))

An optical disk device (6) for accessing an optical disk (3) according to another typical embodiment of the present invention comprises an optical pickup which irradiates the optical disk with a laser light via an objective lens, condenses the reflected light of the irradiated laser light to the light-sensitive surface of plural photo detectors (A-H), and generates an analog signal (A-H) corresponding to an amount of reflected light for each of the plural photo detectors; and a signal shaping unit (240, 202) which shapes the analog signal. The optical disk device further comprises a signal generating unit (204-206) which generates a signal (a total signal, a focus error signal, and a tracking error signal) to be used for the servo control for controlling the optical pickup so as to control a position of a light spot in the optical disk on the basis of the analog signal shaped; an offset change amount detector (207) which detects an amount of change of an offset amount superimposed on the signal to be used for the servo control; and a servo control unit which controls the optical pickup by performing processing for the servo control on the basis of the signal to be used for the servo control. The signal shaping unit (240) compensates an amount of the offset control which has been set up so as to reduce the amount of offset superimposed on the analog signal in initial setting for light detection corresponding to an optical disk loaded, according to the amount of change of the offset amount detected, then, the signal shaping unit (240) adjusts the analog signal on the basis of the amount of offset control after the compensation.

In the optical disk device according to Paragraph 6, the offset control is performed for plural analog signals generated by the plural photo detectors, on the basis of the amount of offset control after the compensation. Accordingly, the amount of change of the offset amount of the signal generated by the analog signal and to be used for the servo control is also reduced. Therefore, the circuit for adjusting the offset amount of the signal to be used for the servo control becomes unnecessary, and, as is the case with Paragraph 1, even when the offset amount changes due to environmental variations, such as temperature and power supply voltage, it becomes possible to perform the stable servo control.
(7) (Feeding Back the Amount of Offset Control after the Compensation to each Analog Signal)

In the optical disk device according to Paragraph 6, the signal to be used for the servo control includes a total signal generated on the basis of a summation of the analog signals (A-D) corresponding to predetermined photo detectors (A-D) among the plural photo detectors (A-H), and the offset change amount detector detects the amount of change of the offset amount of the total signal. Furthermore, the signal shaping unit calculates the amount of change of the offset amount for each analog signal corresponding to the predetermined photo detector, on the basis of the amount of change of the offset amount of the total signal, and the signal shaping unit adjusts the analog signal on the basis of the amount of change of the offset amount calculated for the each analog signal.

According to the present device, by calculating the amount of change of the offset amount for each of the analog signals corresponding to the predetermined photo detectors from the amount of change of the offset amount of the total signal, it is possible to obtain the amount of change of the offset amount for each of the analog signals. Accordingly, it is possible to reduce the offset amount of the analog signal included as a component of the total signal with great accuracy, therefore, it is also possible to remove the offset component of the total signal which is most influenced by the offset amount, with a higher degree of accuracy.
(8) (The Analog Signal as an Adjustment Target is Selectable.)

In the optical disk device according to Paragraph 7, the analog signal as an adjustment target of the signal shaping unit is selectable.
(9) (Sampling an Amount of Offset Change in a Time Sharing Manner (Embodiment 4))

An optical disk device (7) for accessing an optical disk (3) according to yet another typical embodiment of the present invention comprises an optical pickup (10) which irradiates the optical disk with a laser light via an objective lens, condenses the reflected light of the irradiated laser light to the light-sensitive surface of plural photo detectors (A-H), and generates an analog signal (A-H) corresponding to an amount of reflected light for each of the plural photo detectors; and a signal shaping unit (252, 253, 202) which shapes an analog signal of the each photo detector. The optical disk device further comprises a signal generating unit (204-206) which generates a signal (a total signal, a focus error signal, and a tracking error signal) to be used for the servo control for controlling the optical pickup so as to control a position of a light spot in the optical disk on the basis of the analog signal shaped by the signal shaping unit; an offset change amount detector (250, 251) which detects, in a time sharing manner for each photo detector, the amount of change of the offset amount superimposed on an analog signal of each photo detector, shaped by the signal shaping unit; and a servo control unit (219) which performs the servo control on the basis of the signal to be used for the servo control. In the signal shaping unit, an amount of initial offset control is set up for each photo detector so as to reduce the offset amount superimposed on the analog signal of each photo detector, in the initial setting of the light detection corresponding to an optical disk loaded. The signal shaping unit compensates the amount of initial offset control for each corresponding photo detector according to the amount of change of the offset amount, and adjusts the analog signal concerning the corresponding photo detector, on the basis of the amount of offset control after the compensation.

In the optical disk device according to Paragraph 9, the amount of change of, the offset amount is detected in a time sharing manner for each analog signal corresponding to each photo detector, and the offset control is performed for each analog signal. Accordingly, the amount of change of the offset amount of the signal generated by the analog signal and to be used for the servo control is also reduced. Therefore, the circuit for adjusting the offset amount of the signal to be used for the servo control becomes unnecessary, and, as is the case with Paragraph 1, even when the offset amount changes due to environmental variations, such as temperature and power supply voltage, it becomes possible to perform the stable servo control. The offset change amount detector detects the amount of change of the offset amount in a time sharing manner for each analog signal corresponding to each photo detector. Therefore, it is not necessary to provide the offset change amount detector to each of the analog signal as a detection target, thereby contributing to reduction of the circuit scale.

### (10) (A Semiconductor Device)

A semiconductor device (20-23) according to a typical embodiment of the present invention controls an optical pickup (10) and performs processing for accessing an optical disk (3). The semiconductor device comprises a signal generating unit (204-206) which inputs an analog signal (A-H) generated by the optical pickup corresponding to an amount of reflected light of a laser light irradiated to the optical disk, and generates a signal (a total signal, a focus error signal, and a tracking error signal) to be used for the servo control for controlling a light spot in the optical disk; and an offset change amount detector (207, 237) which detects an amount of change of an offset amount superimposed on the signal to be used for the servo control. The semiconductor device further comprises a signal shaping unit (208-217) which shapes the signal to be used for the servo control; and a servo control unit (219) which performs the servo control on the basis of the signal shaped by the signal shaping unit. The signal shaping unit compensates an amount of the offset control which has been set up so as to reduce the offset amount in initial setting for light detection corresponding to an optical disk loaded, according to the amount of change of the offset amount detected, and adjusts the signal to be used for the servo control on the basis of the amount of the offset control after the compensation.

According to the present device, as is the case with Paragraph 1, even when the offset amount changes due to environmental variations, such as temperature and power supply voltage, it becomes possible to perform the stable servo control.
(11) (A Semiconductor Device: a Configuration of the Offset Change Amount Detector (Embodiment 1))

In the semiconductor device according to Paragraph 10, the offset change amount detector (207) calculates a difference between a peak value of the signal detected after completing the initial setting and to be used for the servo control and a peak value of a signal to be used for the servo control, and sets the difference as the amount of change of the offset amount.

According to the present device, it is possible to easily calculate the amount of change of the offset amount of the signal to be used for the servo control.
(12) (A Semiconductor Device: a Configuration of the Offset Change Amount Detector (Embodiment 2))

In the semiconductor device according to Paragraph 10, the offset change amount detector (237) calculates an amount of change of a peak value which indicates how much the peak value of the signal to be used for the servo control has changed after the completion of the initial setting, in consideration of a rate of change of amplitude of the signal to be used for the servo control after the completion of the initial setting, and sets the calculated amount of change of the peak value as the amount of change of the offset amount.

According to the present device, as is the case with Paragraph 3, the amount of change of the amplitude is also taken into consideration when calculating the amount of change of the peak value; therefore, it is, possible to detect the amount of change of the offset amount with a higher degree of accuracy.

### 2. Details of Embodiments

The embodiments are further explained in full detail.

### Embodiment 1

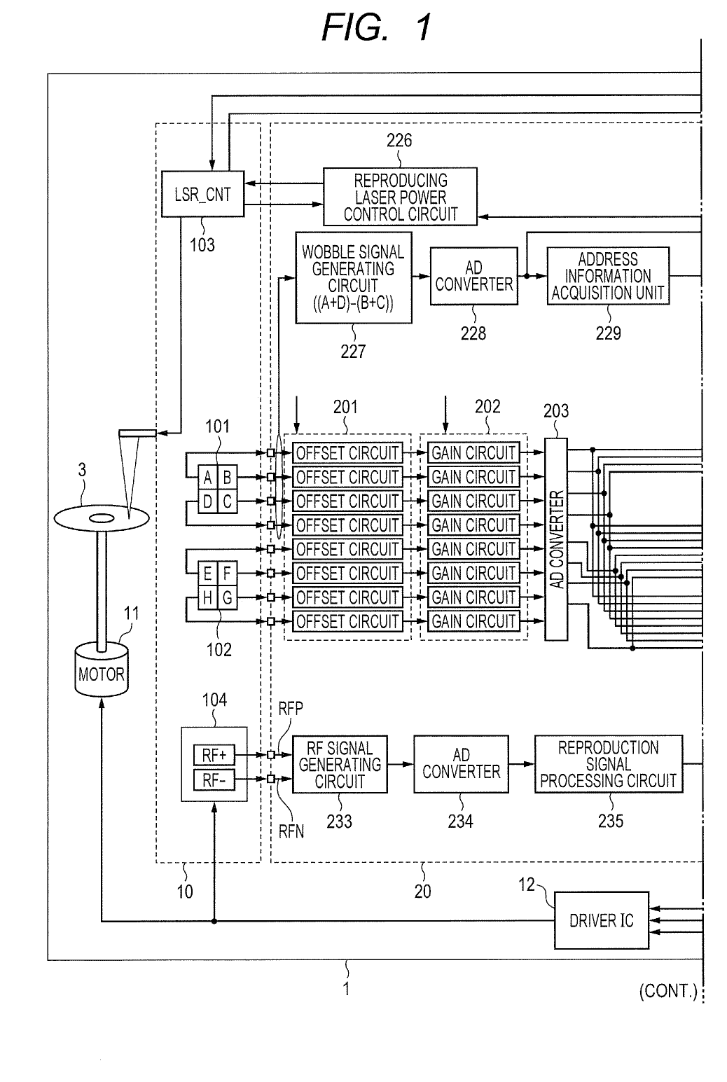

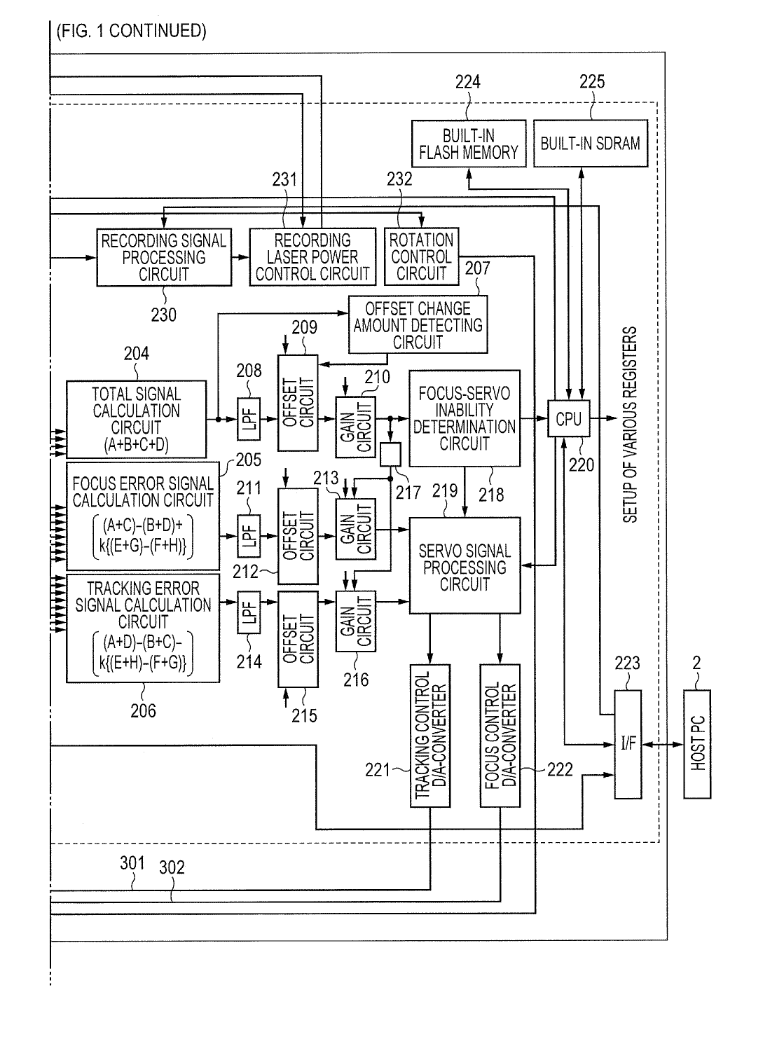

FIG. 1 is a block diagram illustrating a configuration of an optical disk device for performing record/reproduction of an optical disk, according to the present embodiment. The optical disk device 1 illustrated in the figure is applied to a BD system, a DVD system, or a multi-disk drive system including a BD and a DVD, for example.

An optical disk 3 which has one or plural information storage layers is mounted in a turntable and rotated by a spindle motor 11. The spindle motor 11 is controlled by a data processing controller 20 via a driver IC 12. In this state, an optical pickup 10 emits a laser light and executes record or reproduction of information to the target information storage layer.

The optical pickup 10 has an optical system which irradiates the information storage layer of the optical disk 3 with a laser light from a laser diode as a semiconductor laser via an objective lens, condenses a reflected light reflected from the information storage layer with a detection lens, and leads it to light detectors 101 and 102. As for the laser light emitted from the laser diode 1 as a light source, the laser power at the time of record and the laser power at the time of reproduction are controlled by a laser controller (LSR_CNT) 103. Specifically, a feedback loop is formed between the laser controller 103 and one of a reproducing laser power control circuit 226 and a recording laser power control circuit 231, which are to be described later; thereby the laser power is controlled to a constant value.

In the optical pickup 10, focus servo control and tracking servo control are performed: the focus servo control controls the position of focal length so as to focus a light spot (beam spot) of the laser light irradiated to the optical disk 3 to a target information storage layer, and the tracking servo control controls the light spot so as to follow a groove (track) provided in the optical disk 3. Servo control, such as the focus servo control and the tracking servo control, is realized by the data processing controller 20 controlling via the driver IC 12.

The laser light irradiated by the optical disk 3 is composed by plural beams divided by a diffraction grating for example. As an example, FIG. 1 illustrates a case where two beams, a main beam and a sub beam, are generated at the time of reproduction of the optical disk 3, and a reflected light of the main beam enters into the light detection unit 101 and a reflected light of the sub beam enters into the light detection unit 102.

The light detection unit 101 is formed by photo detectors A-D. The photo detectors A-D generate and output electrical signals (analog signals) corresponding to the quantity of reflected light of the main beam irradiated to the respective light-sensitive surfaces. Hereinafter, the reference symbols A-D shall express both of the photo detectors and the electrical signals generated by the photo detectors. The electrical signals A-D are inputted into the data processing controller 20 and utilized for generation of a control signal for the servo control. The details of the control signal for the servo control will be described later.

A differential signal generating unit 104 generates a plus-side RF signal RFP and a negative-side RF signal RFN. The plus-side RF signal RFP and the negative-side RF signal RFN are generated based on an electrical signal generated by a photo detector (not shown) which is provided separately from the photo detectors A-D and E-G. The plus-side RF signal RFP is a signal derived from a signal component which is equivalent to an arithmetic expression “A+B+C+D”, for example, and the negative-side RF signal RFN is a signal derived from a signal component which is equivalent to an arithmetic expression “−(A+B+C+D)”, for example. The plus-side RF signal RFP and the negative-side RF signal RFN are inputted into an RF signal generating circuit 233 of the data processing controller 20 and utilized for generation of a reproduction signal concerning the information recorded on the optical disk 3.

The light detection unit 102 is formed by photo detectors E-H. The photo detectors E-H generate and output electrical signals (analog signals) corresponding to the quantity of reflected light of the sub beam irradiated, in a similar way as in the photo detectors A-D. Hereinafter, the reference symbols E-H shall express both of the photo detectors and the electrical signals generated by the photo detectors. The electrical signals E-H are inputted into the data processing controller 20 and utilized for generation of a control signal for the servo control. The details of the control signal for the servo control will be described later.

As described above, the optical pickup 10 is controlled by the peripheral circuit including the data processing controller 20 and the driver IC 12.

The driver IC 12 realizes the focus servo control and the tracking servo control by driving the optical pickup 10 according to servo driving signals 301 and 302 from the data processing controller 20.

The data processing controller 20 performs overall control for performing record or reproduction of information to the optical disk 3 by controlling the driver IC 12. The data processing controller 20 performs generation processing of a recording signal for recording data to the optical disk 3 and decoding processing of a reproduction signal read from the optical disk 3, and communicates with a host PC 2 provided outside. Although not limited in particular, the data processing controller 20 illustrated in FIG. 1 is formed over a semiconductor substrate like single crystal silicon by the well-known CMOS integrated circuit manufacturing technology. The data processing controller 20 does not need to be formed by a single-chip integrated circuit as described above, but may be formed by a multi-chip integrated circuit.

The data processing controller 20 can be separated into, for example, a reproducing system, a recording system, a servo control system, and a control system.

The reproducing system comprises the RF signal generating circuit 233, an AD converter 234, a reproduction signal processing circuit 235, and the reproducing laser power control circuit 226, for example. When reproducing the information recorded on the optical disk 3, the RF signal generating circuit 233 inputs the plus-side RF signal RFP and the negative-side RF signal RFN which are generated by the optical pickup 10, and generates a reproduction RF signal, under instructions from a CPU 220. The reproduction RF signal is converted into a digital signal by the AD converter 234. Under instructions from the CPU 220, the reproduction signal processing circuit 235 executes decoding of the digitized reproduction RF signal, and stores the decoded reproduction data in a built-in SDRAM 225. The reproduction data stored in the built-in SDRAM 225 is transferred to the host PC 2 by the CPU 220 via an external interface (I/F) circuit 223, such as SATA. As described above, the reproducing laser power control circuit 226 performs control so as to keep constant the laser power at the time of reproduction, by forming a feedback loop together with the laser controller 103.

The recording system comprises a wobble signal generating unit 227, an AD converter 228, an address information acquisition unit 229, a recording signal processing unit 230, and the recording laser power control circuit 231, for example. The optical disk 3 is formed with a track groove in advance, and meandering called a wobble is provided for example, in the case of a write once read many optical disk or an erasable optical disk (for example, CD-R/RW, DVD-R single layer/-RW/-R dual layer, DVD+R single layer/+RW/+R dual layer, and BD-R single layer/-RE single layer/-R dual layer/-RE dual layer/-R triple layer/-RE triple layer/-R quadruple layer). Address information used as the guide of a record/reproduction position is embedded in the wobble. In the record of data to the optical disk 3, the record of data is performed with the use of a wobble clock signal which is generated based on the cycle of the wobble, as a reference clock signal. First, the wobble signal generating unit 227 inputs the electrical signals A-D concerning the reflected light of the main beam, for example, and performs analog signal processing to output the wobble signal. Specifically, the wobble signal generating unit 227 generates the wobble signal according to an arithmetic expression “(A+D)−(B+C).” The generated wobble signal is converted into a digital signal by the AD converter 228, and is inputted into a rotation control circuit 232 and the address information acquisition unit 229. The rotation control circuit 232 generates a driving signal for rotating the optical disk 3 based on the wobble signal and outputs it to the driver IC 12; accordingly, the rotation control circuit 232 performs the rotation control of the optical disk 3. The address information acquisition unit 229 analyzes the address information embedded in the wobble based on the wobble signal, and detects a physical address which indicates the position on the optical disk 3. The detected information on the physical address is supplied to the recording signal processing circuit 230. The recording signal processing circuit 230 encodes record data inputted via the external I/F circuit 223 and once stored in the built-in SDRAM 225. Then, the recording signal processing circuit 230 converts the encoded record data into a recording signal based on the information on the physical address, and supplies it to the laser controller 103. As described above, the recording laser power control circuit 231 performs control so as to keep constant the laser power at the time of record, by forming a feedback loop together with the laser controller 103.

The control system comprises the CPU 220, a built-in flash memory 224, the built-in SDRAM 225, and the rotation control circuit 232, for example. The CPU 220 realizes the record and reproduction of information to the optical disk 3, by controlling each functional section of the recording system, the reproducing system, and the servo control system, based on the program stored in the built-in flash memory 224 and others. When the optical disk 3 is loaded to the optical disk device 1, the CPU 220 performs initial setting for light detection, depending on the optical disk 3 loaded. Specifically, the CPU 220 sets initial values to various registers provided in each functional section of the servo control system to be described later so that a signal to be used for servo control may become in an optimal state when performing the servo control; accordingly, the CPU 220 performs the offset control and signal level adjustment of the signal (a total signal, a focus error signal, and a tracking error signal) to be used for servo control and the electrical signals A-H.

The built-in flash memory 224 is a storage device for storing a program and various data for the CPU 220. The built-in flash memory 224 stores, for example, a program for driving the optical disk device 1 and various data, such as a servo control parameter, a strategy parameter, and an LD light emission parameter. Access to the built-in flash memory 224 is controlled by the control instruction from the CPU 220, if needed. The built-in SDRAM 225 is a storage device with a volatile storage area for storing temporarily the arithmetic result by the CPU 220, the reproduction data decoded by the reproduction signal processing circuit 235, and others.

The servo control system generates a signal (a total signal, a focus error signal, and a tracking error signal) to be used for the servo control, based on the electrical signals A-H outputted by the photo detectors, and performs various kinds of servo control based on the generated signal to be used for the servo control.

Generally, the amount of reflected light of the laser light irradiated to an optical disk changes in magnitude, depending on the kind of optical disks, manufacturing variations of optical disks, characteristic variations of photo detectors of the optical pickup 10, etc. Therefore, the amplitude of electrical signals A-H inputted into the data processing controller 20 is not always constant. Offset components can be superimposed in the signal processing process, due to the variations of the circuit characteristics of the functional section which performs the signal processing etc. of the electrical signals A-H, in the data processing controller 20 as a semiconductor device. Consequently, the total signal, the focus error signal, and the tracking error signal, which are generated based on the electrical signals A-H, are not constant in their signal level. If the signal level of these signals which are used for servo control is not constant, there is a possibility that a stable servo control cannot be performed depending on the kind of the optical disk 3 loaded or the manufacturing variations of the data processing controller 20. Accordingly, the data processing controller 20 according to Embodiment 1 performs the waveform shaping of the electrical signals A-H, by removing the offset component and adjusting the signal level of the inputted electrical signals A-H, and performs the waveform shaping of the total signal, the focus error signal, and the tracking error signal, by removing the offset component and adjusting the signal level of these signals. Accordingly, the total signal, the focus error signal, and the tracking error signal are adjusted so that the signal level of these signals may fit in a constant range, independently of the kind of optical disks loaded and manufacturing variation of the data processing controller 20.

The servo control system comprises, for example, offset circuits 201_A-201_H and gain circuits 202_A-202_H which perform waveform shaping of the electrical signals A-H, an AD converter 203 which converts the electrical signals A-H into a digital signal, and a total signal calculation circuit 204, a focus error signal calculation circuit 205, and a tracking error signal calculation circuit 206 which generate a signal to be used for the servo control. The servo control system further comprises, for example, a first group for performing waveform shaping of a signal to be used for the servo control and a second group for performing the servo control. The first group includes low pass filters (LPF) 208, 211, and 214, a PE-signal offset circuit 209, a PE-signal gain circuit 210, an FE-signal offset circuit 212, an FE-signal gain circuit 213, a TE-signal offset circuit 215, a TE-signal gain circuit 216, and a gain control circuit 217. The second group includes a servo signal processing circuit 219, a tracking control D/A-converter 221, a focus control D/A-converter 222, and a focus-servo inability determination circuit 218.

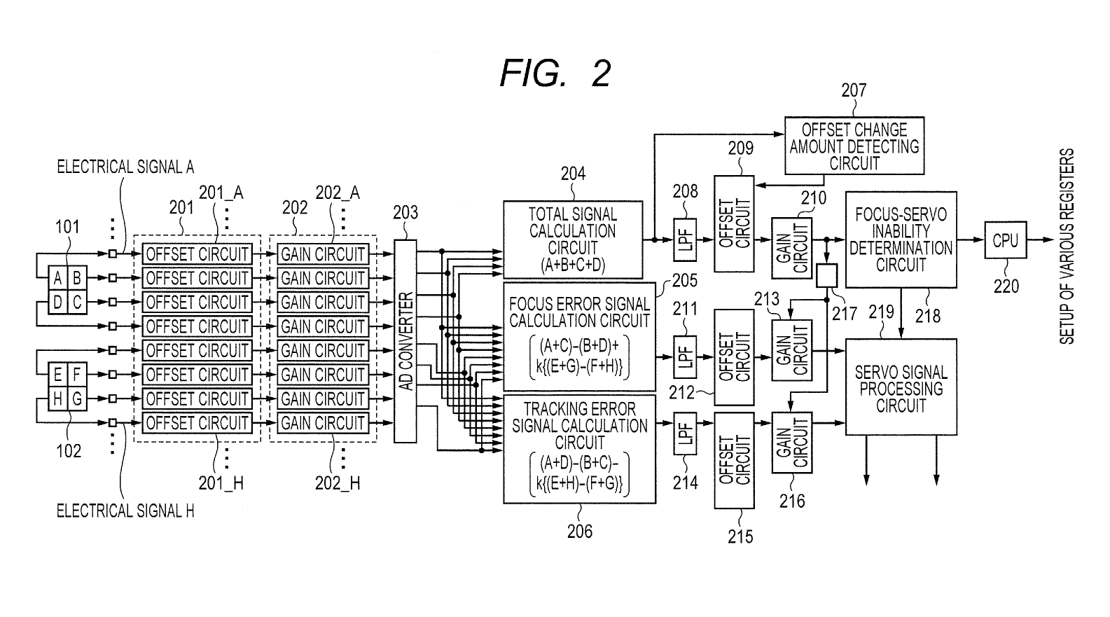

FIG. 2 is a block diagram illustrating an example of a functional section concerning the servo control in the data processing controller 20.

As illustrated in FIG. 2, the electrical signals A-H generated by the light detectors 101 and 102 are respectively inputted into the offset circuits 201_A-201_H (which are collectively expressed as an offset circuit 201). The offset circuit 201 is a circuit for reducing the offset component superimposed on the electrical signals A-H as analog signals. The offset circuit 201 is composed, for example, by a DAC or the like, which performs resistive subdivision of an inputted electrical signal according to a resistance ratio set up and outputs the subdivided signal. For example, the offset circuit 201 is provided with a register in which the amount of offset control for reducing the offset amount of the inputted electrical signal is set up. In the initial setting, the CPU 220 sets to the register the amount of offset control which makes small the offset amount of the electrical signal when the optical disk 3 is loaded. Then, the offset circuit 201 shifts the signal level of the electrical signal, by the resistive subdivision ratio according to the setting value of the register, and outputs the shifted electrical signal. Each register of the offset circuits 201_A-201_H is respectively set up according to each offset amount of the electrical signals A-H to be inputted.

The electrical signals A-H to which the offset control has been made by the offset circuit 201 are respectively inputted into the gain circuits 202_A-202_H (which are collectively expresses as a gain circuit 202). The gain circuit 202 is an amplifier for adjusting the electrical signals A-H from a small signal level to the optimal signal level so that the A/D conversion can be performed with a sufficient accuracy by effectively utilizing the resolution of the AD converter 203 in the following stage. The gain circuit 202 is an inverting amplifier configured with an operational amplifier, a resistor, etc., for example. For example, the gain circuit 202 is provided with a register in which an amplification factor is set up. In the initial setting, the CPU 220 sets to the register an amplification factor which makes the signal level of the electrical signal when the optical disk 3 is loaded equal to a predetermined signal level. Then, the gain circuit 202 amplifies the electrical signal with the amplification factor according to the setting value of the register, and outputs the amplified electrical signal. Each register of the gain circuits 202_A-202_H is respectively set up according to each signal level of the electrical signals A-H to be input.

The electrical signals A-H of which the signal level has been adjusted are respectively converted into a digital signal by the AD converter 203. The total signal calculation circuit 204, the focus error signal calculation circuit 205, and the tracking error signal calculation circuit 206 generate the respective signals to be used for the servo control on the basis of the digitized electrical signals A-H. Specifically, the total signal calculation circuit 204 generates a total (PE) signal, the focus error signal calculation circuit 205 generates a focus error (FE) signal, and the tracking error signal calculation circuit 206 generates a tracking error (TE) signal. Hereinafter, the total signal, the focus error signal, and the tracking error signal are explained in detail.

The total signal corresponds to the total of the amount of reflected light of the main beam, and is calculated by adding the respective values of the electrical signals A-D, for example. Specifically, the total signal calculation circuit 204 inputs the digitized electrical signals A-D and calculates “A+B+C+D” to generate the total signal. The total signal is utilized for inability determination of the focus servo control, or adjustment of the signal level of the focus error signal and the tracking error signal, as will be described later.

The total signal generated by the total signal calculation circuit 204 is smoothed by the low pass filter 208, and is inputted into the PE-signal offset circuit 209. The PE-signal offset circuit 209 is a circuit for reducing the offset component superimposed on the total signal as a digital signal. The PE-signal offset circuit 209 is effective when there is a residual offset component which has not been removed by the offset circuit 201 in the preceding stage, or when an offset component is superimposed by processing with circuit blocks in the latter stages than the offset circuit 201. The details of the PE-signal offset circuit 209 will be described later.

The total signal for which the offset control has been performed is inputted into a PE-signal gain circuit 210. The PE-signal gain circuit 210 adjusts the signal level of the total signal to a predetermined signal level. As described above, the amount of reflected light of the laser light changes depending on the kind of an optical disk or others; accordingly, there arises a case in which the total signal as the total of the amount of reflected light does not exhibit constant amplitude. Accordingly, the PE-signal gain circuit 210 adjusts the signal level of the total signal to a signal level of the predetermined range independently of the kind etc. of the optical disk loaded. For example, the PE-signal gain circuit 210 is provided with a register in which the amplification factor is set up for amplifying the inputted total signal to a predetermined signal level. For example, in the initial setting, the CPU 220 sets to the register an amplification factor which makes the signal level of the total signal when the optical disk 3 is loaded equal to a predetermined signal level. Then, the PE-signal gain circuit 210 amplifies the total signal with the amplification factor according to the setting value of the register, and outputs the amplified total signal.

The total signal of which the signal level has been adjusted by the PE-signal gain circuit 210 is inputted into the focus-servo inability determination circuit 218 and the gain control circuit 217. The gain control circuit 217 is a circuit for adjusting the signal level of the focus error signal and the tracking error signal on the basis of the signal level of the total signal. The details of the gain control circuit 217 will be described later.

The focus-servo inability determination circuit 218 determines whether the focus servo control is practicable or impracticable, by using the signal level of the total signal which changes corresponding to the position of the objective lens with reference to the focus position of the laser light of a target information storage layer.

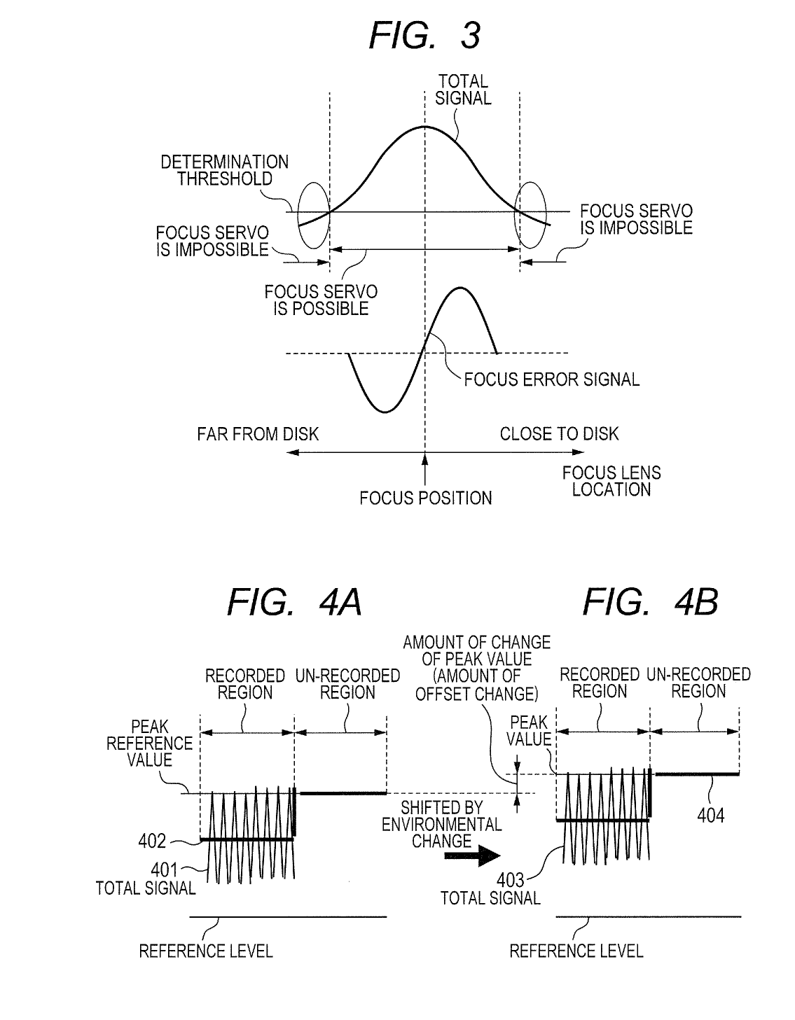

FIG. 3 is an explanatory diagram illustrating an example of a determining method by the focus-servo inability determination circuit 218. As illustrated in the figure, the total signal attains the maximum signal level when the laser light is focusing to the target information storage layer, and the signal level of the total signal decreases as the objective lens departs from the focus position. For example, in the so-called focus search, an actuator in the optical pickup sweeps the objective lens in the direction approaching the optical disk 3, and the focus servo is operated at the position where a zero crossing point of the focus error signal is detected. In the focus search, the objective lens is moved until the zero crossing point is detected, accordingly, if the zero crossing point cannot be detected because of a low level of the focus error signal, it is likely that the objective lens collides with the optical disk 3, and that the objective lens and the optical disk 3 get damaged. Accordingly, by utilizing the fact that the signal level of the total signal decreases as the objective lens departs from the focus position, the focus-servo inability determination circuit 218 monitors the total signal and determines that the focus servo control is impracticable when the signal level of the total signal becomes less than a predetermined threshold (hereinafter also called a determination threshold), then the focus-servo inability determination circuit 218 notifies the CPU 220 of the determination result. Not only in the focus search but in the state where the focus servo is operating, when the signal level of the total signal becomes less than the predetermined threshold, the focus-servo inability determination circuit 218 determines that the focus servo control is not necessary, and notifies the CPU 220 of the determination result. Accordingly, it is possible to make the optical disk device 1 perform an emergency stop processing so that neither the optical disk 3 nor the objective lens may get damaged due to abnormal operations of the actuator and others which drive the objective lens.

Now the focus error signal is explained.

The focus error signal is a signal of which the magnitude changes depending on the position of the objective lens in the optical pickup 10 with reference to the optical disk 3, and is utilized for the focus servo control. For example, when the objective lens rests at a position where correct focus is obtained on the target information storage layer, the main spot forms the shape of a circle so that the light condenses uniformly to each of the photo detectors A-D. When the position of the objective lens is too close, the main spot forms the shape of an ellipse so that the light condenses in a biased manner toward one pair of the photo detectors, and when the position of the objective lens is too far, the main spot forms the shape of an ellipse rotated 90 degrees so that the light condenses in a biased manner toward the other pair of the photo detectors. Therefore, when the objective lens is in the center position of the focusing point, the focus error signal becomes zero. When the objective lens is moved back and forth around the focusing point, the focus error signal changes from zero to a negative value and to zero again, then from zero to a positive value and to zero again; thus depicting the so-called S-shaped waveform. Specifically, the focus error signal calculation circuit 205 inputs the digitized electrical signals A-D and the digitized electrical signals E-H and calculates “(A+C)−(B+D)+k{ (E+G)−(F+H)}” to generate the focus error signal. The coefficient k is determined by the specification of the optical pickup 10. Depending on the configuration of the optical pickup 10, the focus error signal can be generated only by calculating “(A+C)−(B+D).”

The focus error signal generated by the focus error signal calculation circuit 205 is smoothed by the low pass filter 211, and is inputted into the FE-signal offset circuit 212. The FE-signal offset circuit 212 is a circuit for reducing the offset component superimposed on the inputted focus error signal. For example, the FE-signal offset circuit 212 is provided with a register in which the amount of offset control for reducing the offset amount of the inputted focus error signal is set up. In the initial setting, the CPU 220 sets to the register the amount of offset control which makes small the offset amount of the focus error signal when the optical disk 3 is loaded. Then, the FE-signal offset circuit 212 shifts the signal level of the focus error signal, by the setting value of the register, and outputs the shifted focus error signal.

The focus error signal for which the offset control has been performed is inputted into the FE-signal gain circuit 213. The FE-signal gain circuit 213 adjusts the signal level of the focus error signal to a constant level. As described above, the amount of reflected light of the laser light changes depending on the kind of an optical disk or others; accordingly, there arises a case in which the focus error signal does not exhibit constant amplitude. Accordingly, the FE-signal gain circuit 213 adjusts the signal level of the focus error signal to the predetermined signal level independently of the kind etc. of the optical disk loaded. For example, the FE-signal gain circuit 213 is provided with a register in which an amplification factor is set up. For example, in the initial setting, the CPU 220 sets to the register an amplification factor which makes the signal level of the focus error signal when the optical disk 3 is loaded equal to a predetermined signal level. Then, the FE-signal gain circuit 213 amplifies the focus error signal with the amplification factor according to the setting value of the register, and outputs the amplified focus error signal.

However, even if the signal level of the focus error signal is adjusted in the initial setting, there arises a case in which the signal level of the focus error signal changes after that. For example, an information storage surface in the neighborhood of the center of an optical disk and an information storage surface in the neighborhood of the outer circumference may differ in the amount of reflected light, under the influence of a distortion etc. of the optical disk due to manufacturing variations, or an area of the optical disk where data has been recorded and an area where data is not yet recorded may differ in the amount of reflected light. In such a case, a difference occurs in the signal level of the total signal or the focus error signal, depending on an accessed area of the optical disk (for example, the inner side and the outer side of the optical disk). Accordingly, the data processing controller 20 according to Embodiment 1 comprises the gain control circuit 217. The gain control circuit 217 monitors the total signal and calculates the rate of change from the signal level adjusted in the initial setting of the total signal. Then, the gain control circuit 217 adjusts the amplification factor of the FE-signal gain circuit 213 and the TE-signal gain circuit 216 depending on the calculated rate of change of the total signal. For example, when the amount of reflected light is decreased and the signal level of the total signal becomes smaller than that at the time of the initial setting, the amplification factor is adjusted to a value larger than the initial value of the amplification factor set in the register of the FE-signal gain circuit 213, by the rate of change. When the signal level of the total signal becomes larger than that at the time of the initial setting, the amplification factor of the FE-signal gain circuit 213 is adjusted to a value smaller than the initial value of the amplification factor by the rate of change. Accordingly, even when the amount of reflected light changes, the focus error signal is controlled to fit in a fixed range of the signal level.

Now the tracking error signal is explained.

The tracking error signal indicates relative positional relationship between a track on the optical disk 3 and the laser light irradiated to the optical disk 3, and is used for the tracking servo control. Specifically, the tracking error signal calculation circuit 206 inputs the digitized electrical signals A-D and the digitized electrical signals E-H and calculates “(A+D)−(B+C)+k{(E+H)−(F+G))”} to generate the tracking error signal.

The tracking error signal generated by the tracking error signal calculation circuit 206 is smoothed by the low pass filter 214, as is the case with the focus error signal, and then undergoes the offset control by the TE-signal offset circuit 215 and the signal level adjustment by the TE-signal gain circuit 216. As is the case with the FE-signal offset circuit 212, in the initial setting, the CPU 220 sets to the register the amount of offset control which makes small the offset amount of the focus error signal, and the TE-signal offset circuit 215 shifts the signal level of the tracking error signal by the setting value of the register, and outputs the shifted tracking error signal. As is the case with the FE-signal gain circuit 213, in the initial setting, the CPU 220 sets to the register the amplification factor which makes the signal level of the tracking error signal equal to a predetermined signal level, and the TE-signal gain circuit 216 amplifies the tracking error signal with the amplification factor set in the register, and outputs the amplified tracking error signal. As is the case with the FE-signal gain circuit 213, when the level of the total signal changes, the amplification factor of the TE-signal gain circuit 216 is adjusted by the gain control circuit 217, corresponding to the change of the signal level of the total signal.

The focus error signal and the tracking error signal, which have undergone the waveform shaping as described above, are inputted into the servo signal processing circuit 219. Under instructions from the CPU 220, the servo signal processing circuit 219 generates the focus servo control signal for performing the position control of the light spot in the focus direction on the basis of the inputted focus error signal, and generates the tracking servo control signal for performing the position control of the light spot in the radial direction on the basis of the inputted tracking error signal. The generated focus servo control signal is converted into an analog signal by the focus control D/A-converter 222 and inputted into the driver IC 12. Similarly, the generated tracking servo control signal is converted into an analog signal by the tracking control D/A-converter 221 and inputted into the driver IC 12. Then, the driver IC 12 controls the drive of the actuator in the optical pickup 10, etc. based on the focus servo control signal, thereby realizing the focus servo control. Similarly, the driver IC 12 controls the drive of the actuator based on the tracking servo control signal, thereby realizing the tracking servo control.

As described above, the offset component superimposed on the electrical signals A-H is reduced by the offset circuit 201 performing the offset control based on the amount of offset control set up in the initial setting. Similarly, the offset components superimposed on the total signal, the focus error signal, and the tracking error signal are decreased by. the PE-signal offset circuit 209, the FE-signal offset circuit 212, and the TE-signal offset circuit 215, respectively performing the offset control based on the amount of offset control set up in the initial setting. However, as described above, when the reduction of an element size and the reduction of the number of elements in the analog circuit such as the offset circuit 201 or the gain circuit 202 which perform an analog signal processing are carried out, it causes increase of the amount of change of the offset amount due to environmental variations, such as changes in temperature and power supply voltage, and it is likely that there arises an adverse influence on stable operation of the optical disk device. Therefore, in the optical disk device 1, the offset change amount detecting circuit 207 is provided in the data processing controller 20, and the offset amount of the total signal is adjusted based on the amount of change of the offset amount.

FIG. 4 is an explanatory diagram illustrating an example of changes of the total signal due to environmental variations. The left-side drawing (A) of FIG. 4 illustrates the total signal 401 after the completion of the initial setting and a signal 402 obtained by smoothing the total signal concerned by the low pass filter 208. The right-side drawing (B) of FIG. 4 illustrates the total signal 403 after environmental changes, such as temperature, and a signal 404 obtained by smoothing the total signal concerned by the low pass filter 208.

As illustrated in the left-side drawing (A) of FIG. 4, the signal level of the total signal 401 becomes small when the laser light hits a recording mark formed in the optical disk, for example, and the signal level becomes large when the laser light hits other parts except for the recording mark. Therefore, the signal level of the total signal 401 changes sinusoidally in the recorded region on which the information is recorded in the optical disk; and the signal level becomes maximum and approximately constant in the un-recorded region on which the information is not recorded in the optical disk. The maximum value (peak value) of the total signal 401 in the recorded region and the value of the total signal in the un-recorded region are nearly equal. When the offset amount changes with the change of the internal temperature, the power supply voltage, etc. of the optical disk device 1, the total signal changes to a signal indicated by a reference symbol 403 due to a shift of the signal level, as illustrated in the right-side drawing (B) of FIG. 4.

Accordingly, by utilizing the fact that the signal level of the total signal is adjusted in the initial setting and the fact that the peak value of the total signal exhibits a nearly equal magnitude, in either of the recorded region and the un-recorded region of the optical disk, the offset change amount detecting circuit 207 calculates the difference between the peak value of the total signal 401 before the environmental change and the peak value of the total signal 403 after the environmental change. Accordingly, it is possible to detect how much the offset amount of the total signal 401 has changed after the completion of the initial setting.

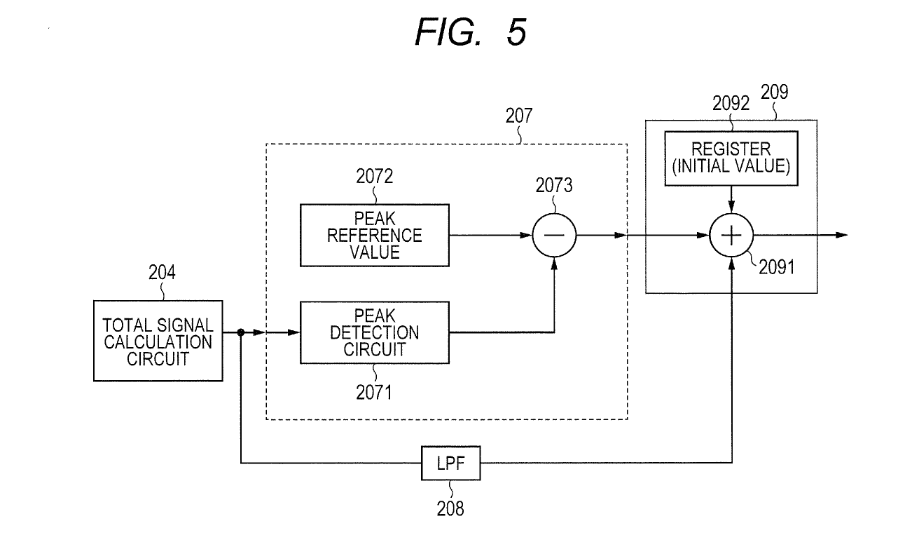

FIG. 5 is a block diagram illustrating an example of a circuit configuration of the offset change amount detecting circuit 207. As illustrated in the figure, the offset change amount detecting circuit 207 comprises a peak detection circuit 2071, a peak reference value register 2072, and a subtractor 2073, for example. The peak detection circuit 2071 detects and holds the peak value of the total signal, and outputs it to the subtractor 2073. In the peak reference value register 2072, a peak value of the total signal after the completion of the initial setting (also called a peak reference value hereinafter) is stored. For example, a value detected by the peak detection circuit 2071 immediately after the completion of the initial setting by the CPU 220 is stored. The subtractor 2073 subtracts the value detected by the peak detection circuit 2071 from the value of the peak reference value register 2072, and outputs the subtracted value as an amount of offset change.

The PE-signal offset circuit 209 comprises an adder 2091 and an offset control register 2092, for example. In the initial setting after loading of the optical disk 3, the CPU 220 sets to the offset control register 2092 the amount of offset control which makes small the offset amount superimposed on the total signal when the optical disk 3 is loaded. Then, the adder 2091 shifts the signal level of a total signal by adding the total signal inputted via the low pass filter 208, the value of the offset control register 2092, and the amount of offset change detected by the offset change amount detecting circuit 207, and outputs the shifted total signal. Accordingly, the offset control in consideration of the change of the offset amount due to environmental variations is realized.

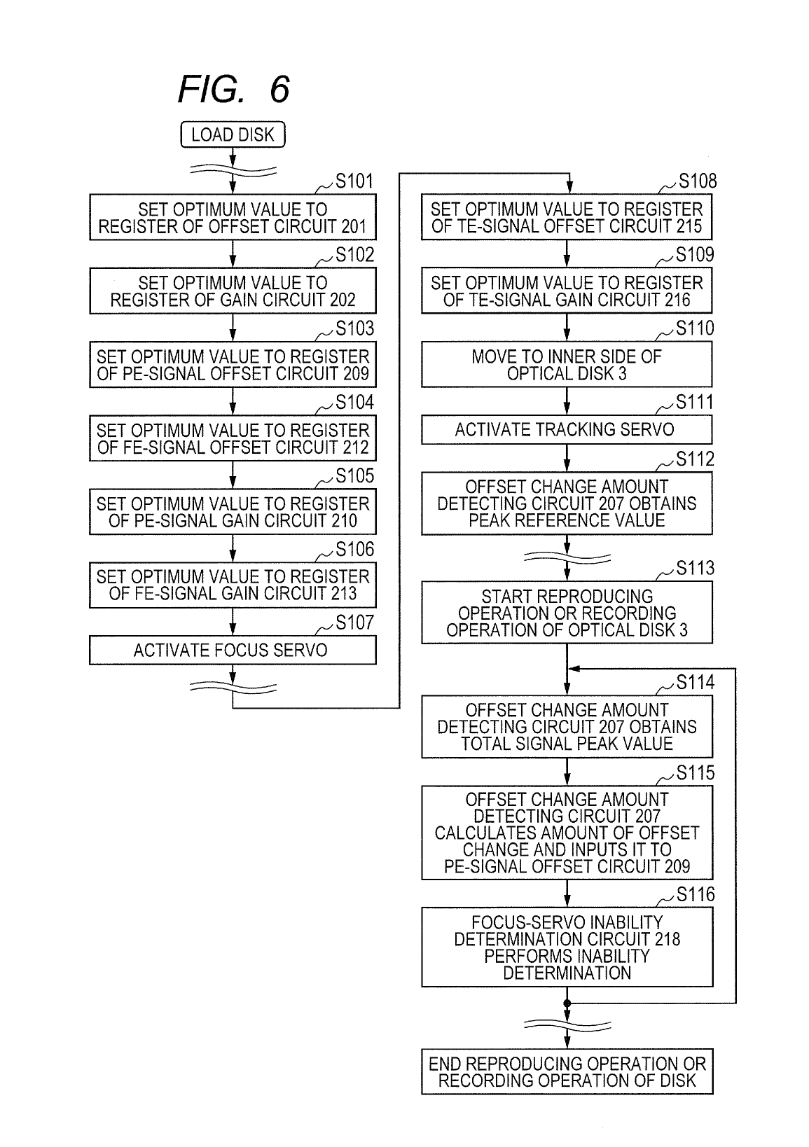

FIG. 6 is a flow chart illustrating an example of a flow of reproducing operation (or recording operation) of the optical disk device 1.

When the optical disk 3 is loaded in the optical disk device 1, the CPU 220 starts initial setting for light detection. First, the CPU 220 grasps the offset amount superimposed on the electrical signals A-H by referring to the signal level of the electrical signals A-H, and sets the optimum value (initial value) of the amount of offset control to each register of the offset circuits 201_A-201_H, based on the offset amount (S101). The CPU 220 also sets the optimum value (initial value) of the amplification factor to each register of the gain circuits 202_A-202_H (S102). Next, the CPU 220 grasps the offset amount superimposed on the total signal by referring to the signal level of the total signal, and sets the optimum value (initial value) of the amount of offset control to the register 2092 of the PE-signal offset circuit 209, based on the offset amount (S103). The CPU 220 grasps the offset amount superimposed on the focus error signal by referring to the signal level of the focus error signal, and sets the optimum value (initial value) of the amount of offset control to the register of the FE-signal offset circuit 212, based on the offset amount (S104).

Next, the CPU 220 sets the optimum value (initial value) of the amplification factor to the register of the PE-signal gain circuit 210 (S105). The CPU 220 also sets the optimum value (initial value) of the amplification factor to the register of the FE-signal gain circuit 213 (S106). Then, the CPU 220 instructs the servo signal processing circuit 219 to start the focus servo control; accordingly the focus servo is executed (S107). After that, the CPU 220 grasps the offset amount superimposed on the tracking error signal by referring to the signal level of the tracking error signal, and sets the optimum value (initial value) of the amount of offset control to the register of the TE-signal offset circuit 215, based on the offset amount (S108). The CPU 220 also sets the optimum value (initial value) of the amplification factor to the register of the TE-signal gain circuit 216 (S109). After that, the light spot is moved toward the inner side (to the center) of the optical disk 3 (S110). Then, the CPU 220 instructs the servo signal processing circuit 219 to start the tracking servo control, accordingly the tracking servo is executed (S111). After that, the offset change amount detecting circuit 207 detects and holds the peak value of the total signal, and sets the held value to the peak reference value register 2072 as the peak reference value (S112). Accordingly, the state of the total signal before environmental variations is held.

After that, when recognition of the optical disk 3 is completed, the CPU 220 instructs the functional section of the reproducing system (or recording system) to start the reproducing (or recording) of the optical disk 3; accordingly the reproducing operation (or recording operation) is started (S113). During the reproducing operation (or during the recording operation), the offset change amount detecting circuit 207 always detects the peak value of the total signal (S114). The offset change amount detecting circuit 207 calculates the amount of offset change based on the peak value detected and the peak reference value, and supplies the calculated amount of offset change to the PE-signal offset circuit 209 (S115). The focus-servo inability determination circuit 218 performs the inability determination of the focus servo control based on the total signal to which the offset control has been performed (S116). During the reproducing operation (or during the recording operation), the processing of Step S114—Step S116 is always executed.

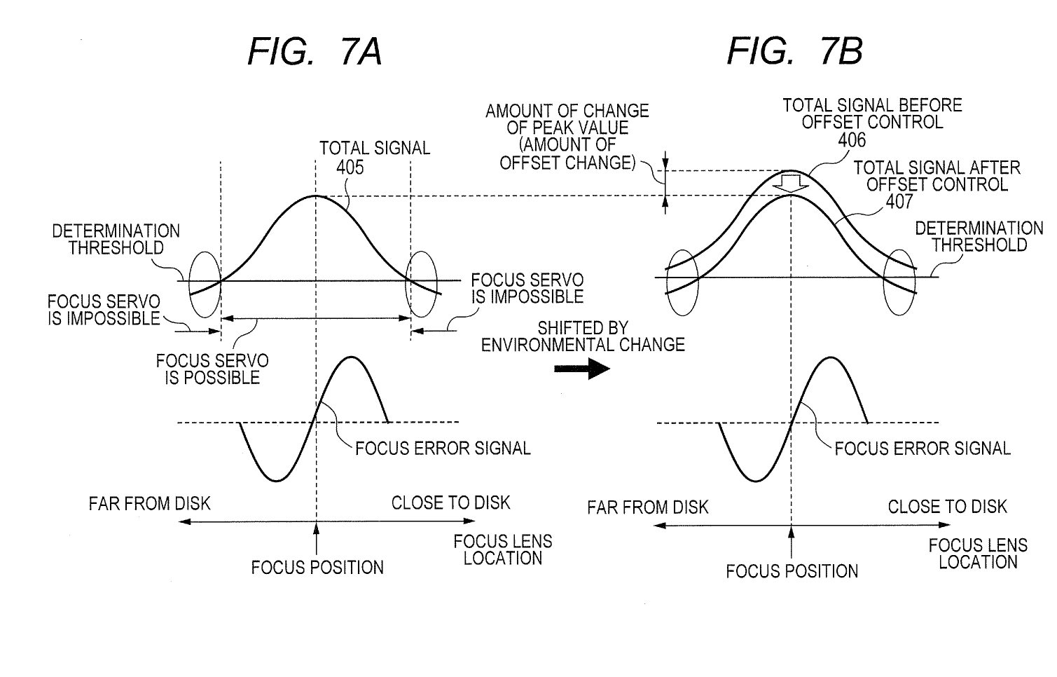

FIG. 7 is an explanatory diagram illustrating an example of focus-servo inability determination after the offset control with consideration given to the amount of offset change. The left-side drawing (A) of FIG. 7 illustrates the relation between the total signal after the completion of the initial setting by the CPU 220, and a determination threshold. The right-side drawing (B) of FIG. 7. illustrates the relation between the total signal after environmental changes such as temperature, and the determination threshold.

As illustrated in the left-side drawing (A) of FIG. 7, the total signal after the completion of the initial setting is a signal indicated by a reference symbol 405. When an offset amount changes due to environmental variations, as illustrated in the right-side drawing (B) of FIG. 7, the total signal changes to a signal indicated by a reference symbol 406, due to a shift of the signal level. In the present case, even when the objective lens departs from the focus position, the total signal 406 does not become less than the determination threshold. Therefore, even if the focus servo becomes abnormal and the objective lens approaches the optical disk too much, it is likely that the focus servo inability cannot be detected, and that the optical disk gets damaged. According to the offset control by the optical disk device 1, the offset control of the total signal is performed in consideration of the amount of change of the offset amount due to environmental variations. Therefore, the total signal is controlled so as to be a signal level indicated by a reference symbol 407, which is not much different from the one before the environmental variations. Accordingly, when the objective lens departs from the focus position, the total signal 407 becomes less than the determination threshold. Therefore, it is possible to detect the inability of the focus servo normally.

As described above, by employing the optical disk device 1 according to Embodiment 1, even if the amount of change of the offset amount of the circuit due to environmental variations becomes large, as the result of the reduction of the element size and the reduction of the number of elements in the analog circuit in the data processing controller 20, it is possible to remove the offset component of the total signal in real time, by taking into consideration the amount of offset change due to environmental variations. Accordingly, it is possible to generate the total signal which is not influenced by environmental variations, therefore, it is possible to maintain the focus error signal and the tracking error signal at the respective optimal signal levels, irrespective of environmental variations, and it is possible to realize the stable focus servo control and the stable tracking servo control, even in an optical disk which yields a small amount of reflected light. It is also possible to detect the focus servo inability normally, irrespective of environmental variations, by generating the total signal which is not influenced by environmental variations.

As described above, the arithmetic expression of the focus error signal and the tracking error signal includes a term of subtraction between the sums of two electrical signals. Therefore, if the offset amount of the electrical signals A-H changes in the same direction uniformly, the offset component included in the focus error signal or a tracking error signal generated will become small relatively. On the other hand, since no term of subtraction is included in the arithmetic expression of the total signal, the offset component included in the total signal becomes large relatively. The total signal is utilized also for adjustment of the signal level of the focus error signal and the tracking error signal, as described above. Therefore, it is particularly effective from the reason described above to perform the offset control for the total signal which is most vulnerable to the change of the offset amount due to environmental variations among the signals used for the servo control, taking into consideration the amount of offset change due to environmental variations, as in Embodiment 1. However, not only for the total signal but also for the focus error signal and the tracking error signal, it is also possible to detect each amount of offset change, to feed back the detected amount of offset change to each of the FE-signal offset circuit 212 and the TE-signal offset circuit 215, and to perform the offset control in consideration of the amount of offset change. Accordingly, it becomes possible to remove the offset component of the focus error signal and the tracking error signal with a higher degree of accuracy.

### Embodiment 2

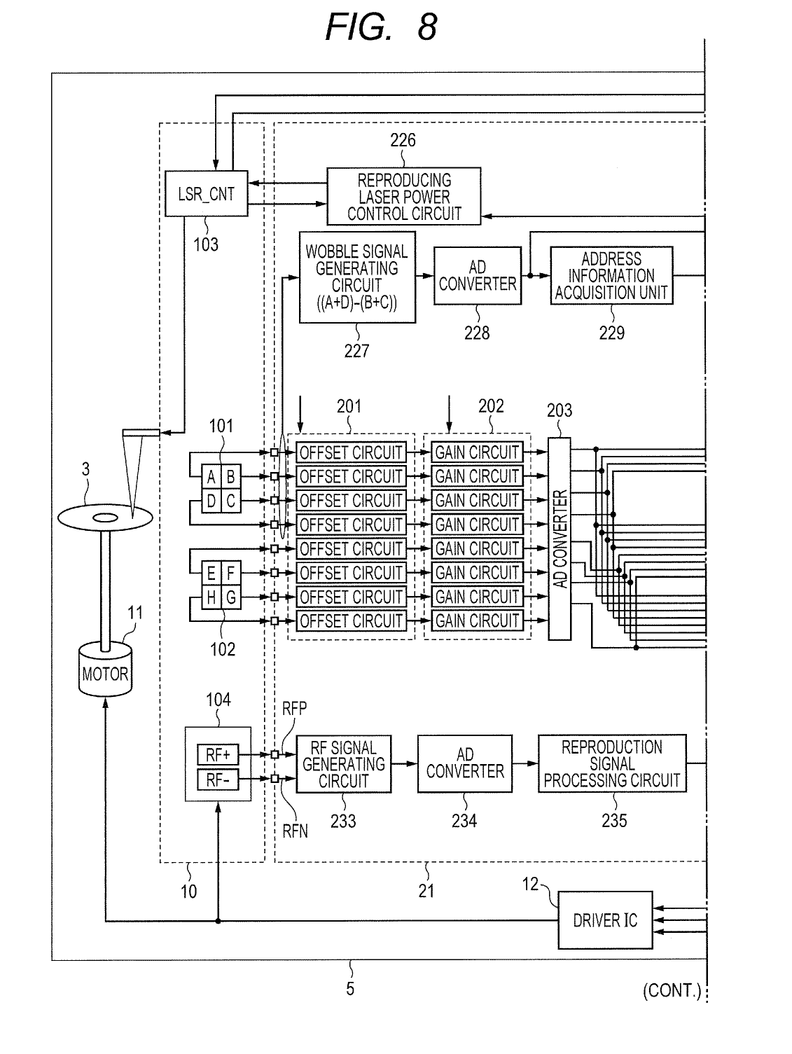

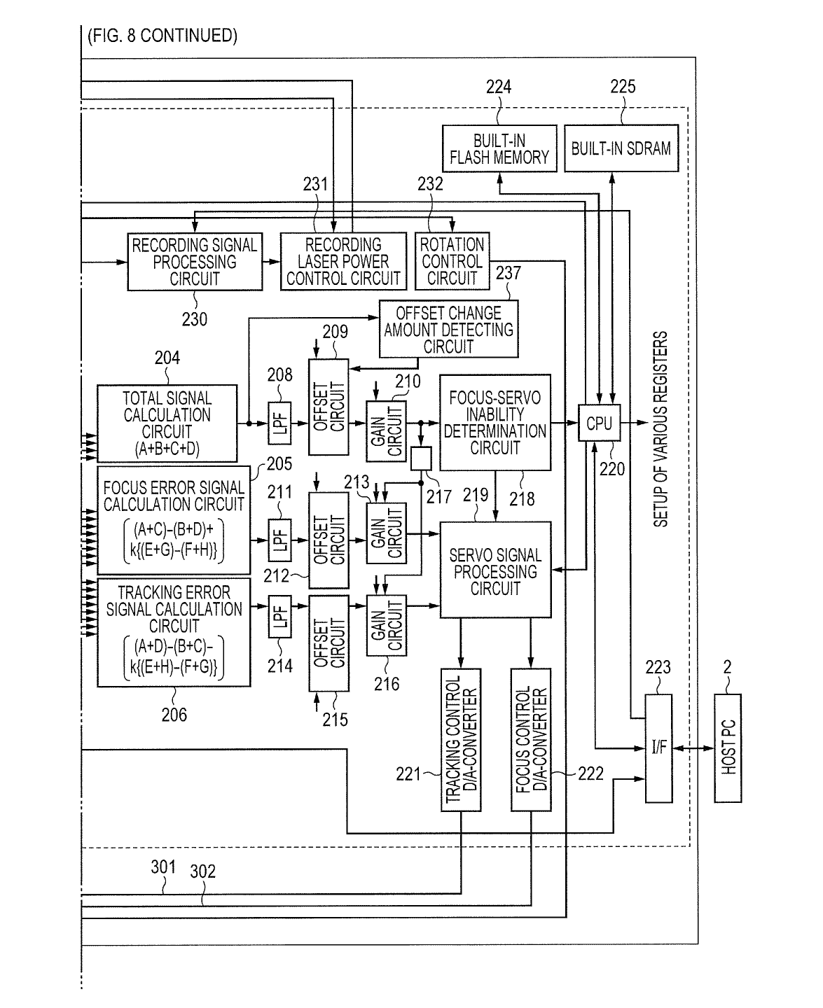

FIG. 8 is a block diagram illustrating a configuration of an optical disk device according to Embodiment 2. The optical disk device 5 illustrated in the figure has an offset change amount detecting circuit 237 in lieu of the offset change amount detecting circuit 207. The offset change amount detecting circuit 237 detects the amount of offset change of the total signal, with the additional consideration given to the amount of change of the amplitude of the total signal.

Although not limited in particular, a data processing controller 21 illustrated in FIG. 8 is formed over a semiconductor substrate like single crystal silicon by the well-known CMOS integrated circuit manufacturing technology, as is the case with the data processing controller 20. The data processing controller 21 does not need to be formed by a single-chip integrated circuit as described above, but may be formed by a multi-chip integrated circuit. In the optical disk device 5, the same symbol is attached to the same component as in the optical disk device 1 according to Embodiment 1, and the detailed explanation thereof is omitted.

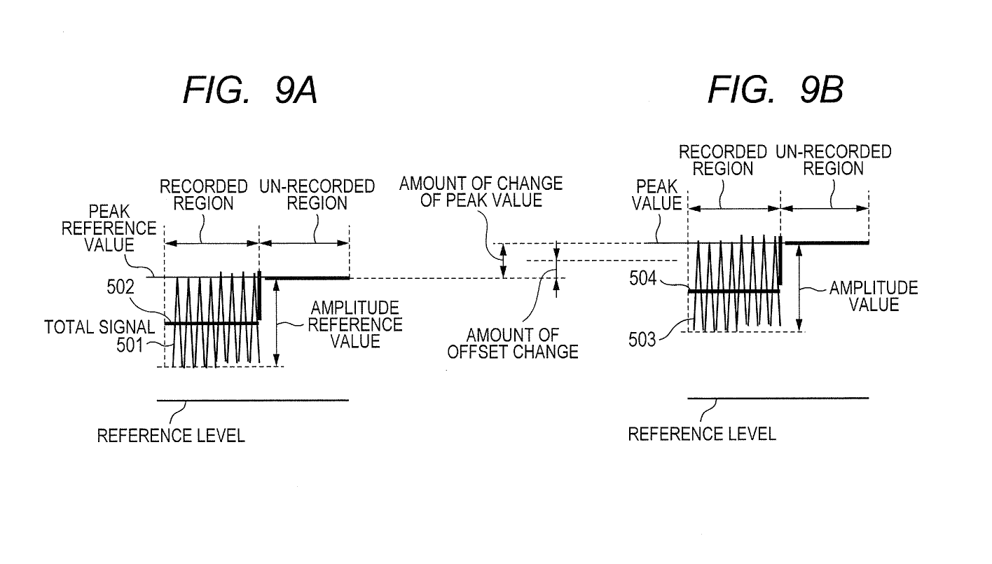

FIG. 9 is an explanatory diagram illustrating another example of changes of the total signal due to environmental variations. The left-side drawing (A) of FIG. 9 illustrates the total signal 501 after the completion of the initial setting and a signal 502 obtained by smoothing the total signal concerned by the low pass filter 208. The right-side drawing (B) of FIG. 9 illustrates the total signal 503 after environmental changes such as temperature, and a signal 504 obtained by smoothing the total signal concerned by the low pass filter 208.

As described above, the peak value of the total signal changes, depending on the internal temperature, etc. of the optical disk device 1. When the amount of reflected light of the laser light changes due to the movement of the accessing target position of the optical disk from the inner side to the outer side or due to other factors, the total signal varies not only in the peak value but also in the amplitude value. It is assumed as an example, in the left-side drawing (A) of FIG. 9, that the peak value of the total signal 501 after the completion of the initial setting (peak reference value) is 2.0V, and that the amplitude value of the total signal 501 after the completion of the initial setting (hereinafter also called an amplitude reference value) is 1.0V. It is also assumed, in the right-side drawing (B) of FIG. 9, that the peak value of the total signal 503 after environmental changes is 2.3V, and that the amplitude value of the total signal 503 is 1.1V. In the present case, when the difference is calculated between the peak reference value (2.0V) of the total signal 501 before the environmental changes and the peak value (2.3V) of the total signal 503 after the environmental changes, the calculated difference (0.3V) includes not only the amount of offset change but also the amount of change of the amplitude. Therefore, if the calculated difference is fed back to the PE-signal offset circuit 237 as it is, it is likely that the offset control will be performed excessively. Accordingly, the offset change amount detecting circuit 237 calculates the amount of offset change of the total signal, in consideration of the rate of the change of the amplitude of the total signal before and after the environmental changes. Specifically, assuming that the peak reference value is Vpref, the amplitude reference value is Vwref, the amplitude value is Vw, and the peak value is Vp; then, the offset change amount detecting circuit 237 calculates the amount of offset change in terms of an arithmetic expression “Vpref×Vw/Vwref−Vp.” For example, in the case of the numerical example assumed above, the arithmetic expression gives that 2.0×(1.1/1.0)−2.3=−0.1(V); accordingly it becomes possible to, detect only the amount of offset change.

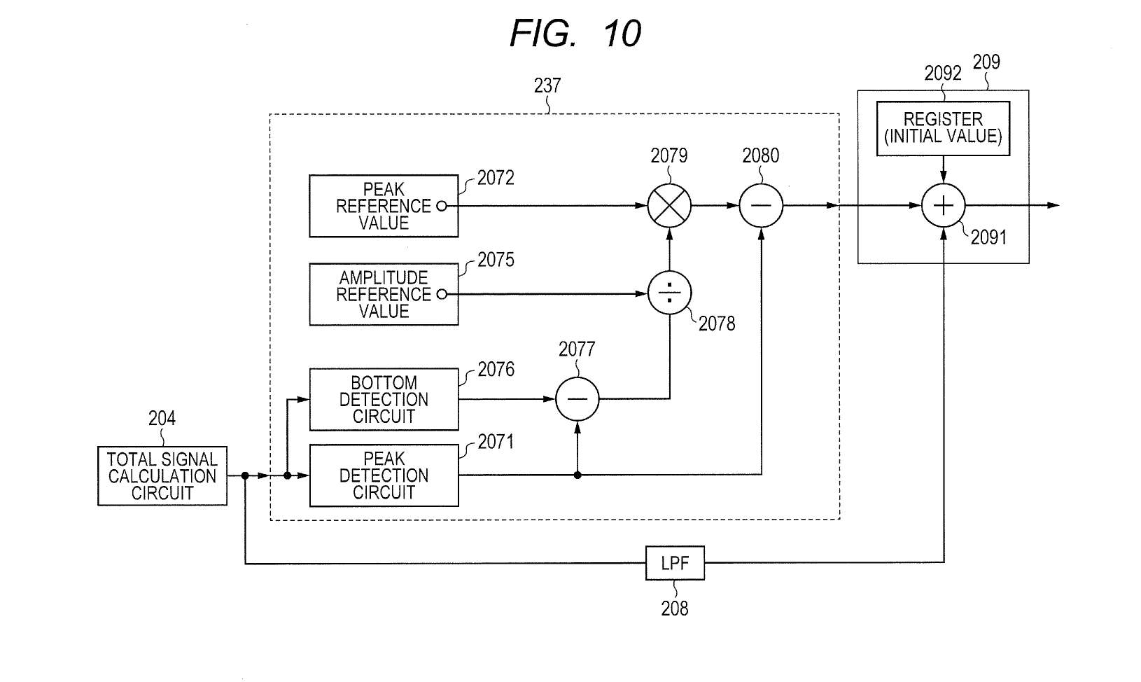

FIG. 10 is a block diagram illustrating an example of a circuit configuration of the offset change amount detecting circuit 237 for achieving the calculation. As illustrated in the figure, the offset change amount detecting circuit 237 comprises, for example, a peak detection circuit 2071, a peak reference value register 2072, an amplitude reference value register 2075, a bottom detection circuit 2076, subtractors 2077 and 2080, a divider 2078, and a multiplier 2079.

The bottom detection circuit 2076 detects and holds the minimum value (bottom value) of the total signal, and outputs it to the subtractor 2077. The subtractor 2077 subtracts the bottom value detected by the bottom detection circuit 2076 from the peak value detected by the peak detection circuit 2071, and calculates the amplitude value of the total signal therewith. The amplitude reference value register 2075 stores, for example, the amplitude value of the total signal calculated by the subtractor 2077 immediately after the completion of the initial setting, as the amplitude reference value. The divider 2078 divides the amplitude value of the total signal calculated by the subtractor 2077 by the amplitude reference value set in the amplitude reference value register 2075, and outputs the result. The multiplier 2079 multiplies the peak reference value stored in the peak reference value register 2072 by the value calculated by the divider 2078, and outputs the result. The subtractor 2080 subtracts the value detected by the peak detection circuit 2071 from the value calculated by the multiplier 2079, and outputs the subtracted value as the amount of offset change. Providing the above circuit configuration, it is possible to detect only the amount of change of the offset amount, excluding the amount of change of the amplitude.

As is the case with Embodiment 1, the PE-signal offset circuit 209 adds the total signal inputted via the low pass filter 208, the value of the offset control register 2092, and the amount of offset change detected by the offset change amount detecting circuit 237, and outputs the shifted total signal. Accordingly, the offset control in consideration of the change of the offset amount due to environmental variations is realized.

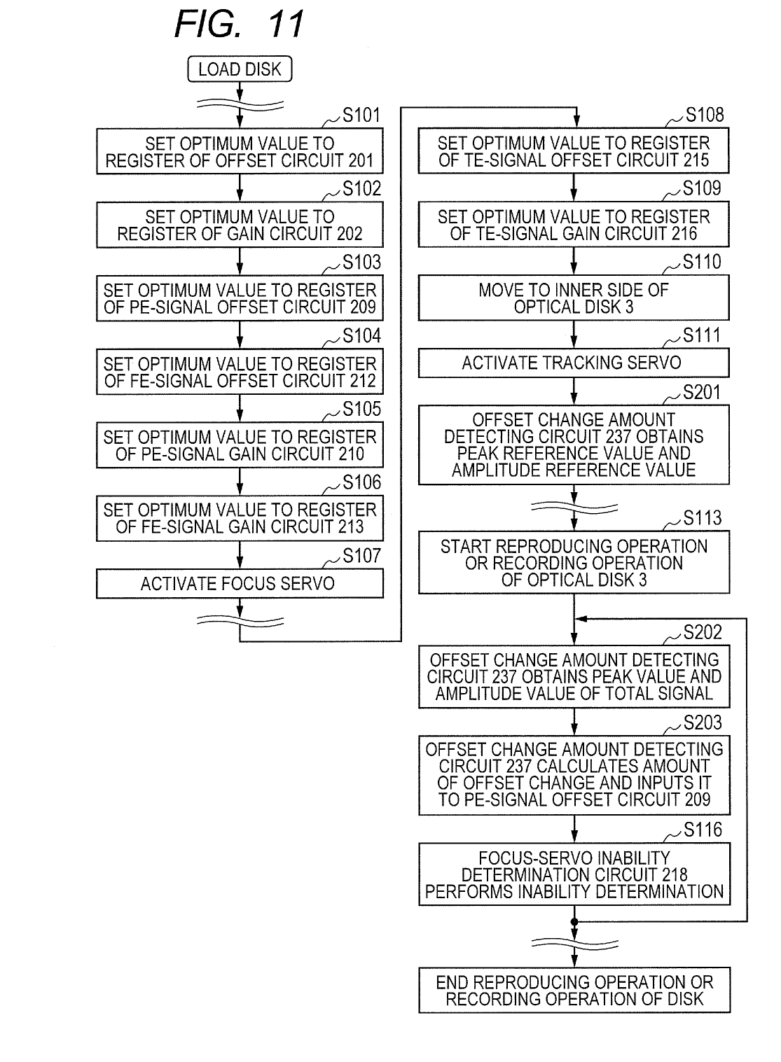

FIG. 11 is a flow chart illustrating an example of a flow of reproducing operation (or recording operation) of the optical disk device 5.

When the optical disk 3 is loaded in the optical disk device 5, the CPU 220 starts initial setting for light detection. Processing at Steps S101-S111 is the same as that of the process flow (FIG. 6) of the optical disk device 1. When the tracking servo is executed at Step S111, the offset change amount detecting circuit 237 detects the peak value of the total signal and sets it to the peak reference value register 2072 as the peak reference value, and calculates the amplitude value and sets it to the amplitude reference value register 2075 as the amplitude reference value (S201). Accordingly, the state of the total signal before environmental variations is held.

After that, when recognition of the optical disk 3 is completed, the CPU 220 instructs the functional section of the reproducing system (or recording system) to start the reproducing (or recording) of the optical disk 3; accordingly the reproducing operation (or recording operation) is started (S113). During the reproducing operation (or during the recording operation), the offset change amount detecting circuit 237 always detects the peak value and the amplitude value of the total signal (S202). The offset change amount detecting circuit 237 calculates the amount of offset change based on the detected peak value, the detected amplitude value, the peak reference value, and the amplitude reference value, and supplies the calculated amount of offset change to the PE-signal offset circuit 209 (S203). The focus-servo inability determination circuit 218 performs the inability determination of the focus servo control based on the total signal to which the offset control has been made (S116). During the reproducing operation (or during the recording operation), the processing at Steps S202, S203, and S116 is always executed.

As described above, by employing the optical disk device 5 according to Embodiment 2, as is the case with Embodiment 1, it is possible to remove the offset component of the total signal in real time, by taking into consideration the amount of offset change due to environmental variations. Even when the amount of reflected light of the laser light changes and the amplitude of the total signal changes during the reproducing operation or the recording operation, it is possible to detect only the amount of offset change due to environmental variations; therefore, it is possible to remove the offset component from the total signal with a higher degree of accuracy. Accordingly, it is possible to generate the total signal which is not influenced by environmental variations. Therefore, it is possible to maintain the focus error signal and the tracking error signal at the respective optimal signal levels, irrespective of environmental variations, and it is possible to realize the stable focus servo control and the stable tracking servo control, even in an optical disk which yields a small amount of reflected light. It is also possible to detect the focus servo inability normally, irrespective of environmental variations, by generating the total signal which is not influenced by environmental variations.

### Embodiment 3

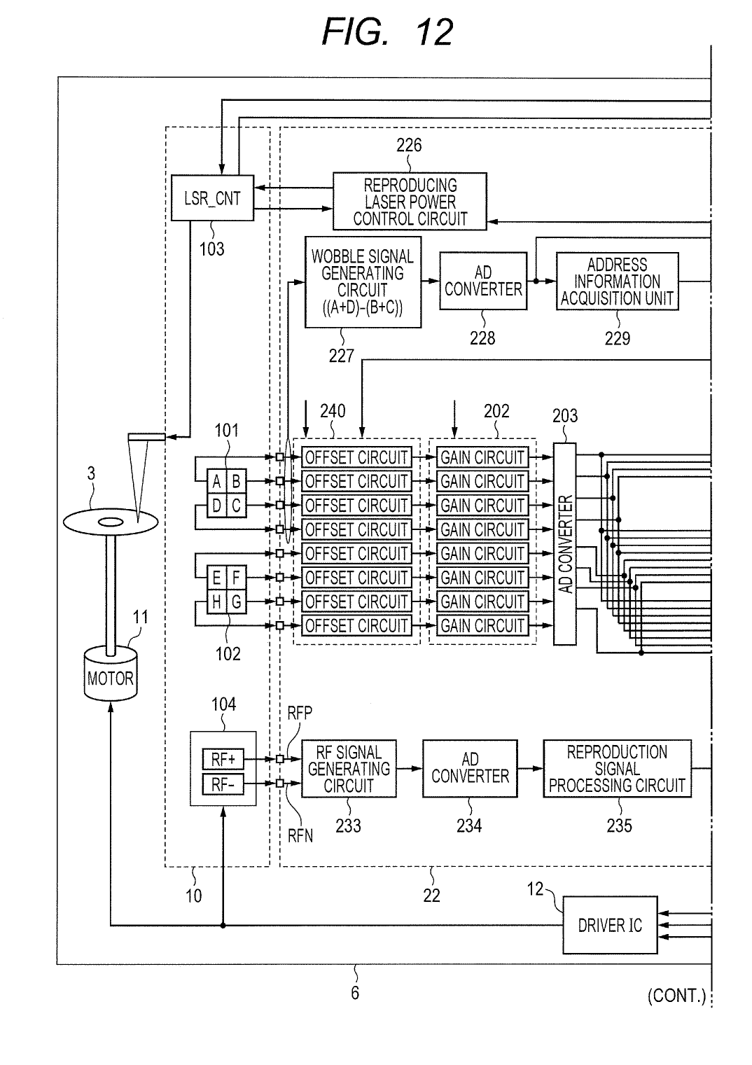

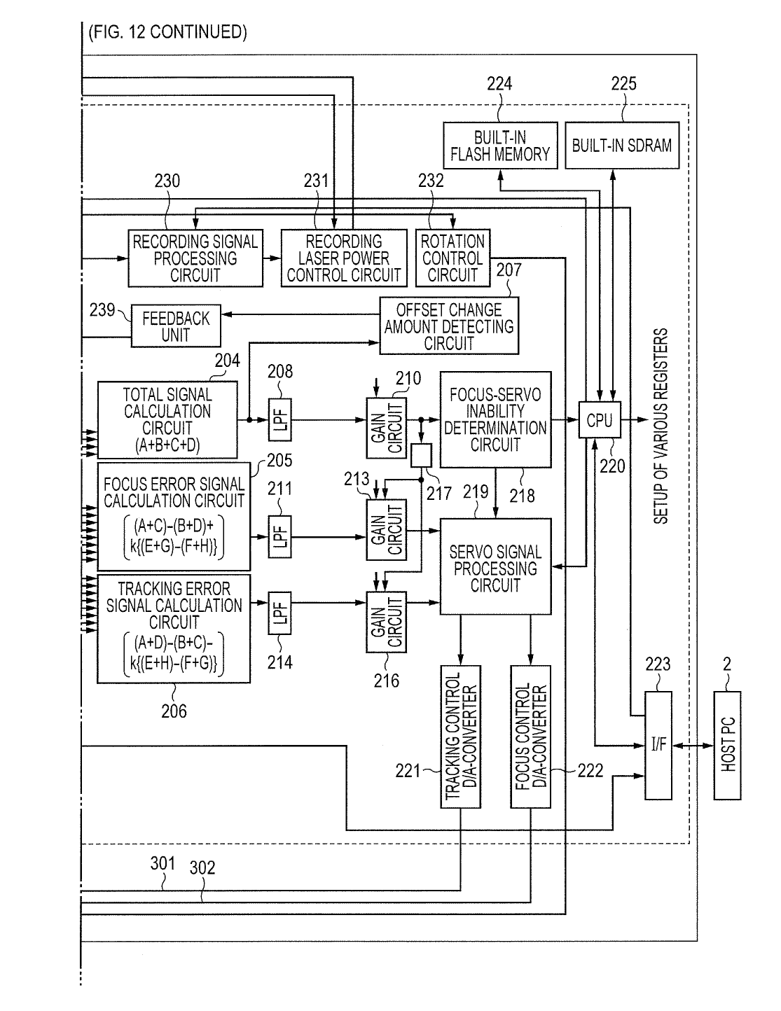

FIG. 12 is a block diagram illustrating a configuration of an optical disk device according to Embodiment 3. The optical disk device 6 illustrated in the figure feeds back the detected amount of offset change of the total signal to the offset circuits 240_A-240_H which perform the offset control of the electrical signals A-H. Thereby, the offset control is performed with the consideration given to the amount of offset change of the electrical signals A-H due to environmental variations.

Although not limited in particular, a data processing controller 22 illustrated in FIG. 8 is formed over a semiconductor substrate like single crystal silicon by the well-known CMOS integrated circuit manufacturing technology, as is the case with the data processing controller 20. The data processing controller 22 does not need to be formed by a single-chip integrated circuit as described above, but may be formed by a multi-chip integrated circuit. In the optical disk device 6, the same symbol is attached to the same component as in the optical disk devices 1 and 5, and the detailed explanation thereof is omitted.

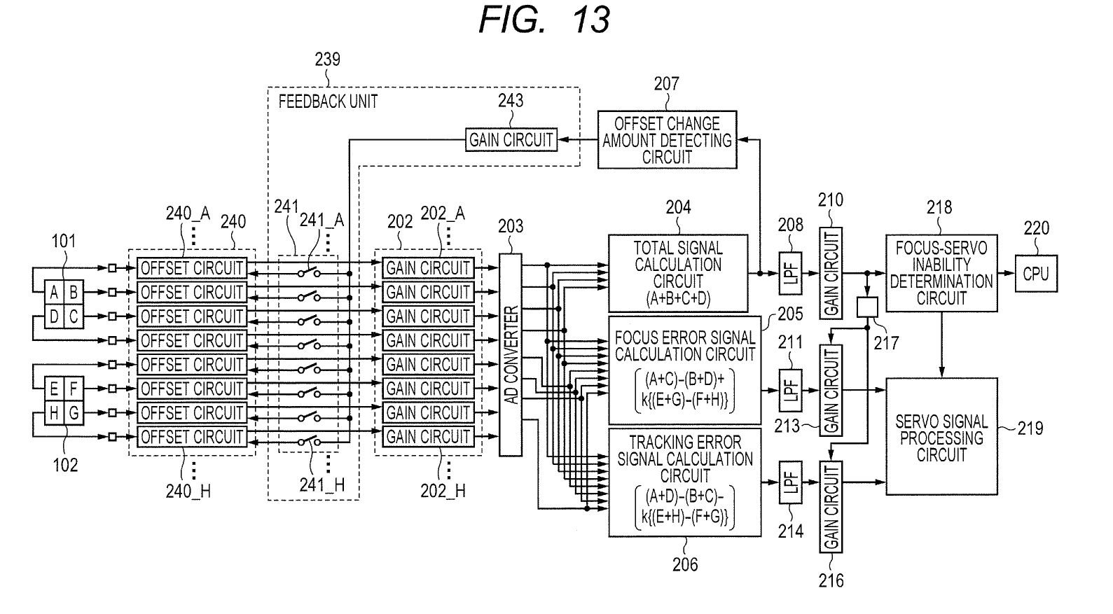

FIG. 13 is a block diagram illustrating an example of a functional section concerning servo control in the data processing controller 22.

As illustrated in FIG. 13, the offset change amount detecting circuit 207 and the feedback unit 239 form a path for feeding back the amount of offset change of the total signal to the offset circuits 240_A-240_H (which are collectively expressed as an offset circuit 240).

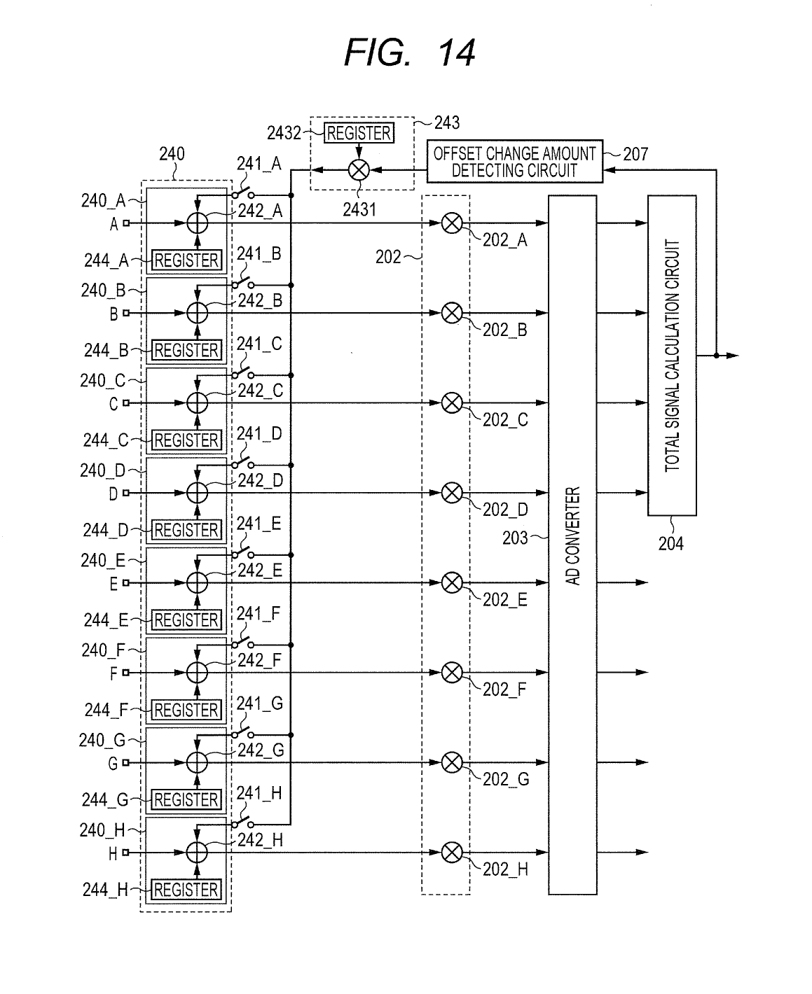

FIG. 14 is an explanatory diagram illustrating details of the functional section forming the feedback path to the offset circuit 240.

The amount of offset change of the total signal detected by the offset change amount detecting circuit 207 is inputted into the feedback unit 239. The feedback unit 239 comprises, for example, a gain circuit 243 and switching circuits 241_A-241_H (which are collectively expressed as a switching circuit 241). The gain circuit 243 calculates an amount of offset change per electrical signal (also called an amount of unit offset change hereinafter) from the amount of offset change. The gain circuit 243 comprises a multiplier 2431 and a register 2432, for example. The multiplier 2431 multiplies the amount of offset change outputted from the offset change amount detecting circuit 207 by a value of the register 2432, to calculate the amount of unit offset change. The register 2432 stores a value for determining the rate of feedback of the amount of offset change, for example. For example, the total signal is total of four electrical signals A-D as described above; accordingly, it means the fact that the respective offset amounts of four electrical signals are added in the total signal.

Therefore, the gain is adjusted in order to feed back the amount of offset change per electrical signal. For example, when feeding back ¼ of the amount of offset change of the total signal as the amount of unit offset change, “0.25” is set to the register 2432. In this way, by changing the value set to the register 2432 if needed, it is possible to arbitrarily increase or decrease the amount of offset change.

The amount of unit offset change generated by the gain circuit 243 is inputted into the offset adjustment circuits 240_A-240_H selected by the switching circuits 241. The on/off of the switching circuit 241 is controlled by the CPU 220. For example, when the offset control is performed only for the electrical signals A-D relating to the total signal in consideration of the amount of offset change due to environmental variations, the CPU 220 turns on the switches 241_A-241_D, and turns off the switches 241_E-241_H. When the offset control is performed for all the electrical signals A-H in consideration of the amount of offset change due to environmental variations, the CPU 220 turns on all the switches 241_A-241_H. Accordingly, it is possible to arbitrarily select an electrical signal to which the offset control is performed in consideration of the amount of offset change due to environmental variations.

The offset circuits 240_A-240_H are provided corresponding to each of the electrical signals A-H, and perform the offset control of the corresponding electrical signal. The circuit configuration of each of the offset circuits 240_A-240_H is the same; accordingly, the offset circuit 240_A is explained representatively here.

The offset circuit 240_A comprises a register 244_A and an offset controller 242_A, for example. In the initial setting, the CPU 220 sets to the register 244_A an amount of offset control which makes small the offset amount of the electrical signal when the optical disk 3 is loaded. The offset controller 242_A determines the amount of offset control based on a value of the register 244_A and the amount of unit offset change inputted via the switching circuit 241_A, shifts the signal level of the electrical signal A based on the determined amount of offset control, and outputs the shifted electrical signal A to the gain circuit 202_A. Specifically, the offset controller 242_A is configured with a DAC etc. which performs resistive subdivision of the inputted electrical signal A, corresponding to the set-up resistance ratio and outputs the subdivided electrical signal. For example, the offset controller 242_A adds the amount of the unit offset change to the amount of offset control which has been initially set to the register 244_A, to compensate the amount of offset control. Then, the offset controller 242_A shifts the signal level of the electrical signal by the resistive subdivision ratio corresponding to the amount of offset control after the compensation, and outputs the shifted electrical signal. Accordingly, it becomes possible to perform the offset control of the electrical signals A-H in consideration of the amount of offset change due to environmental variations.

For example, when each of the analog circuits (the offset circuits 240_A-240_H, and the gain circuits 202_A-202_H) corresponding to each of the electrical signals A-H is designed by the same circuit configuration and the same element size, it is highly possible that the offset amount will drift in the same direction depending on an environmental variation. Therefore, it is possible to easily remove the amount of offset change of the electrical signals A-H by detecting the amount of offset change of the total signal due to the environmental variation, and by calculating the amount of unit offset change based on the detected amount of offset change, as in the optical disk device 6. Accordingly, it is possible to reduce the offset component of the signal to be used for the servo control without performing the offset control to the signal to be used for the servo control. Therefore, the PE-signal offset circuit 209, the FE-signal offset circuit 212, and the TE-signal offset circuit 215 become unnecessary, and the chip area of the data processing controller 22 can be reduced. Furthermore, as is the case with Embodiment 1, it is possible to generate the total signal which is not influenced by environmental variations. Therefore, it is possible to maintain the focus error signal and the tracking error signal at the respective optimal signal levels, irrespective of environmental variations, and it is possible to realize the stable focus servo control and the stable tracking servo control, even in an optical disk which yields a small amount of reflected light. It is further possible to detect the focus servo inability normally, irrespective of environmental variations, by generating the total signal which is not influenced by environmental variations.

### Embodiment 4

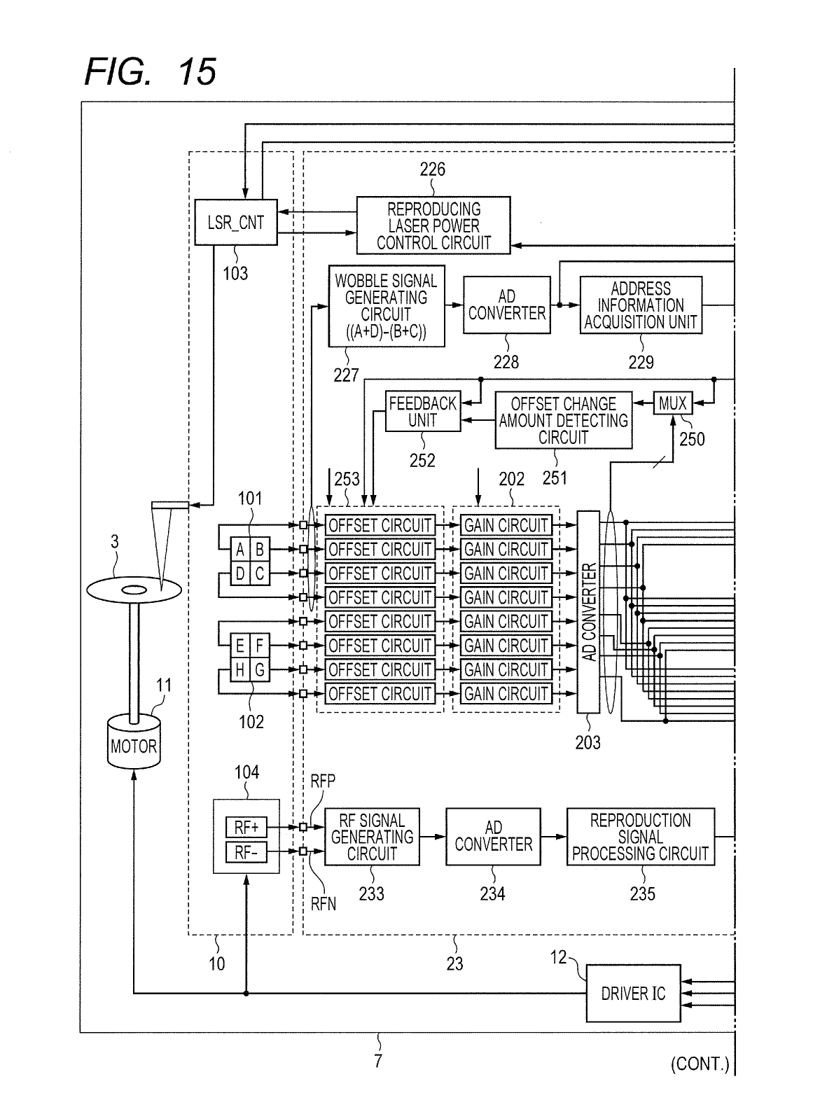

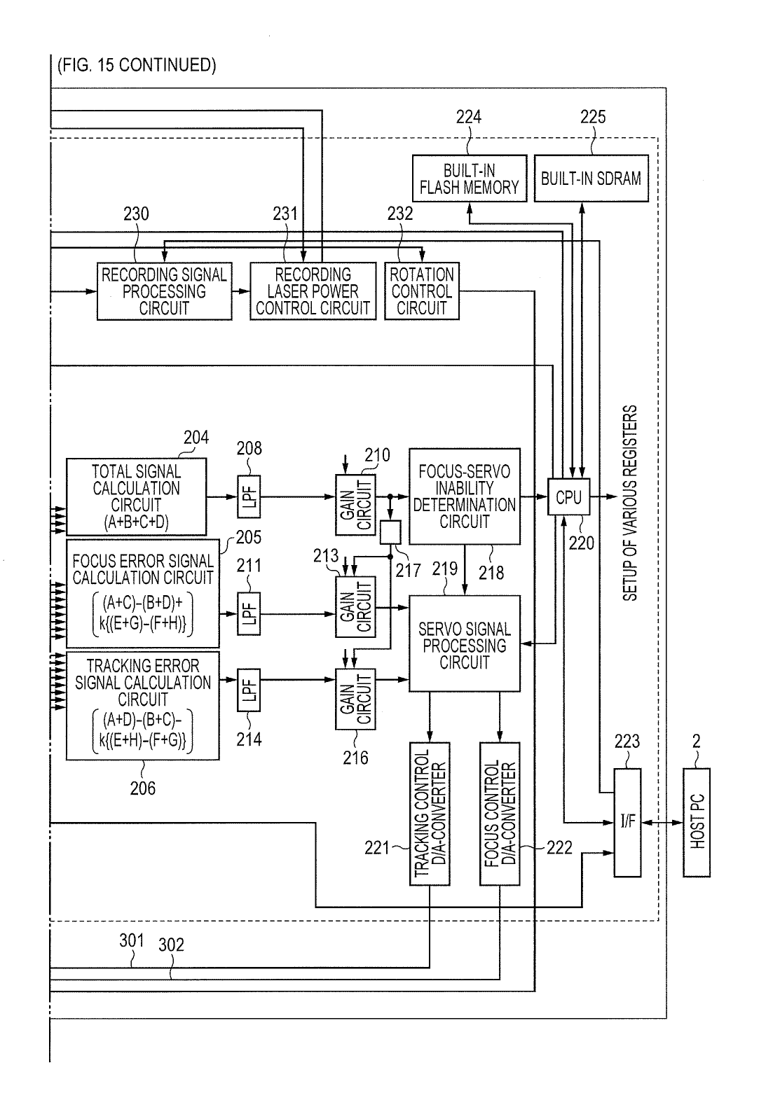

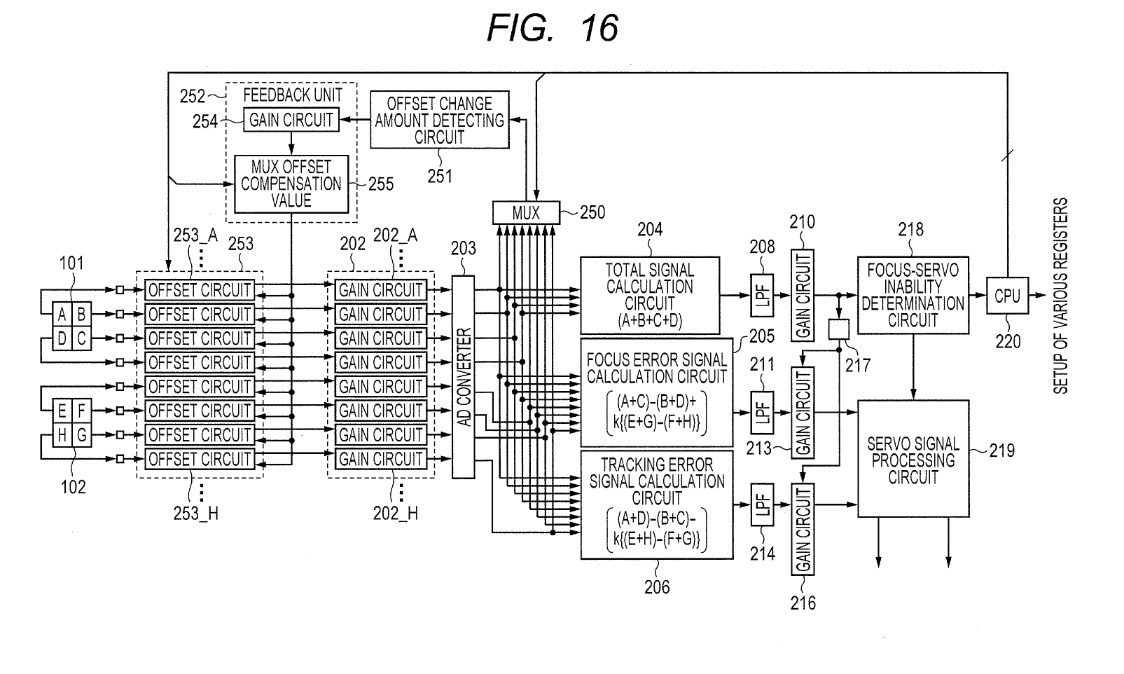

FIG. 15 is a block diagram illustrating a configuration of an optical disk device according to Embodiment 4. The optical disk device 7 illustrated in the figure detects the amount of offset change of the electrical signals A-H by time sharing, and feeds them back to the offset circuits 253_A-253_H which perform the offset control of the electrical signals A-H; accordingly, the optical disk device 7 performs the offset control with consideration given to the amount of offset change of the electrical signals A-H due to environmental variations.

Although not limited in particular, a data processing controller 23 illustrated in FIG. 15 is formed over a semiconductor substrate like single crystal silicon by the well-known CMOS integrated circuit manufacturing technology, as is the case with the data processing controller 20. The data processing controller 23 does not need to be formed by a single-chip integrated circuit as described above, but may be formed by a multi-chip integrated circuit. In the optical disk device 7, the same symbol is attached to the same component as in the optical disk devices 1, 5, and 6, and the detailed explanation thereof is omitted.

FIG. 16 is a block diagram illustrating an example of a functional section concerning servo control in a data processing controller 23.

As illustrated in FIG. 16, a path which feeds back the amount of offset change of the electrical signals A-H to the offset circuits 253_A-253_H is formed by a selection circuit (MUX) 250, an offset change amount detecting circuit 251, and a feedback unit 252.

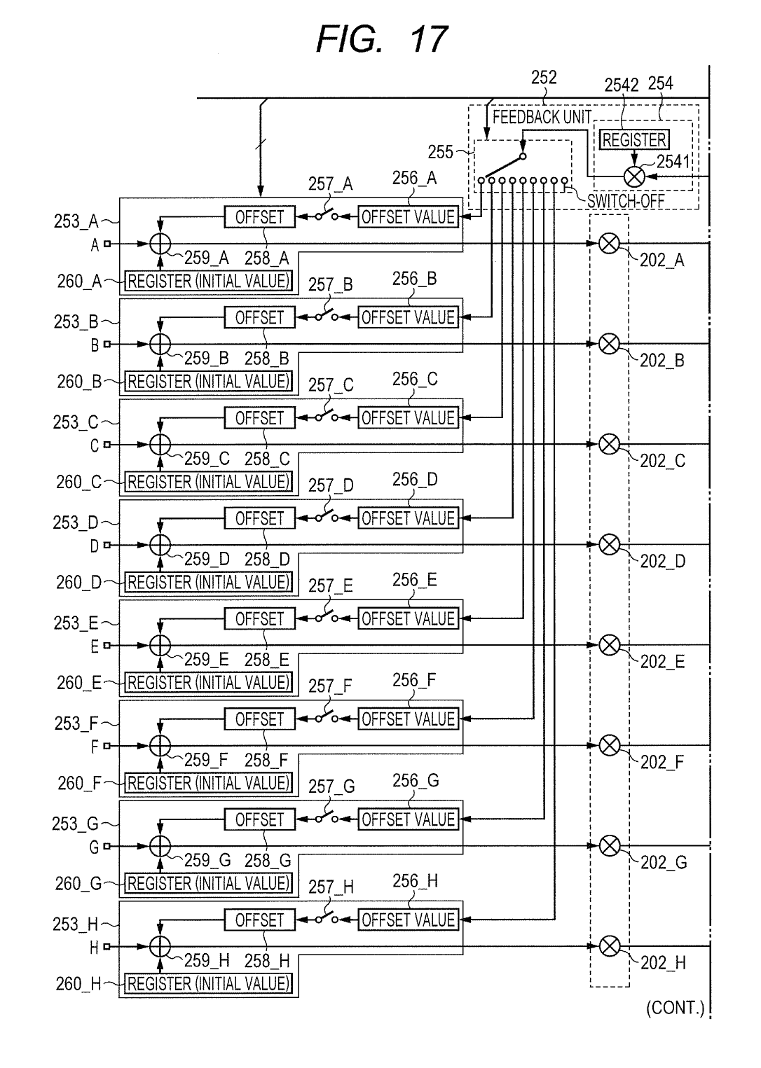

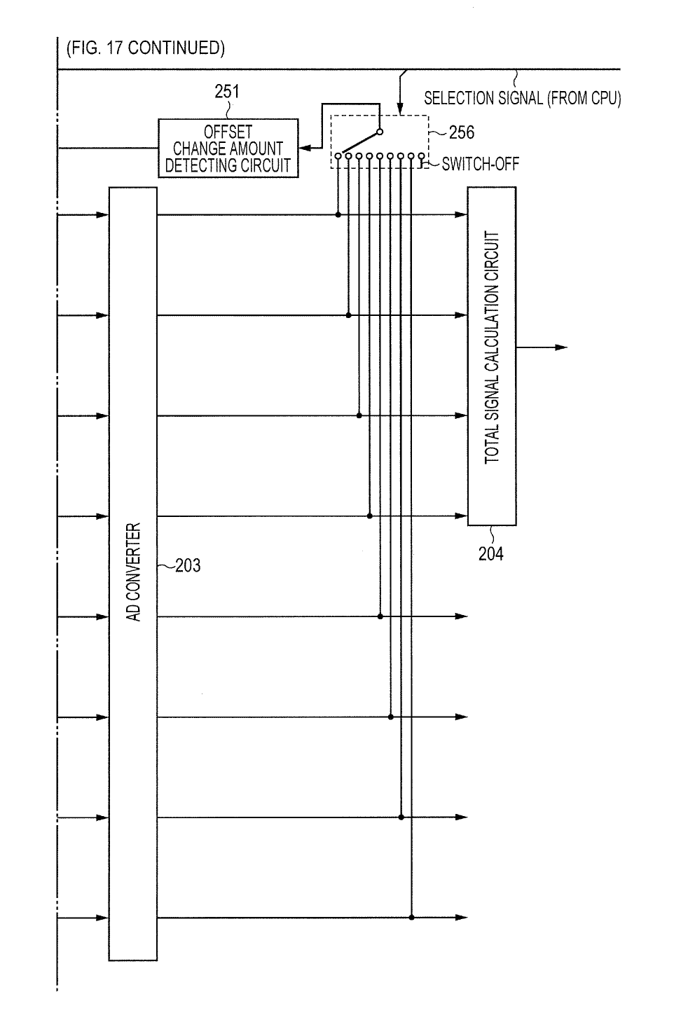

FIG. 17 is an explanatory diagram illustrating details of a functional section forming the feedback path to the offset circuits 253_A-253_H.

The electrical signals A-H digitized by the AD converter 203 are inputted into the selection circuit 250. The selection circuit 250 selects and outputs one of the electrical signals A-H according to a selection signal supplied from the CPU 220. The electrical signal selected changes, for example, in the order of the electrical signal A, the electrical signal B, . . . , the electrical signal G, and the electrical signal H; however, there is no restriction in particular in the order.

The offset change amount detecting circuit 251 detects and outputs the amount of offset change of the electrical signal selected by the selection circuit 250. The detection of the amount of offset change is performed by detecting the amount of change of the peak value of the electrical signal selected, as is the case with the offset change amount detecting circuit 207. The detected amount of offset change is inputted into the gain circuit 254. The gain circuit 254 comprises a multiplier 2541 and a register 2542, for example. The multiplier 2541 multiplies the amount of offset change of the electrical signal detected by the offset change amount detecting circuit 251 by a value of the register 2542, and calculates and outputs the amount of offset change to be fed back to the offset circuit 253. The register 2542 stores a value for determining the rate of feedback of the amount of offset change, for example. For example, the digitized electrical signals A-H are amplified by the gain circuit 202 as described above, this means the fact that the amount of offset change included in the digitized electrical signals A-H is also amplified. Therefore, when feeding back the amount of offset change, a part as much as amplified by the gain circuit 202 is removed. For example, when the amplification factor of the gain circuit 202_A is 2, the value of the register 2542 is set so that the amplification factor of the gain circuit 254 becomes ½. In this way, by changing the value set to the register 2542 if needed, it is possible to arbitrarily increase or decrease the amount of offset change.

The amount of offset change calculated by the gain circuit 254 is inputted into the selection circuit 255. The selection circuit 255 selects one of the offset circuits 253_A-253_H (which are collectively expressed as an offset circuit 253) to which the amount of offset change is fed back according to the selection signal supplied from the CPU 220. The amount of offset change which has undergone the gain adjustment by the gain circuit 254 is inputted into the selected offset circuit 253.

The offset circuits 253_A-253_H are provided corresponding to each of the electrical signals A-H, and perform the offset control of the corresponding electrical signal. The circuit configuration of each of the offset circuits 253_A-253_H is the same; accordingly, the offset circuit 253_A is explained representatively here.

The offset circuit 253_A comprises a first register 256_A, a switching circuit 257_A, a second register 258_A, an offset controller 259_A, and a third register 260_A, for example. The first register 256_A stores temporarily the amount of offset change inputted via the selection circuit 255. The value of the register concerned is updated whenever it is selected by the selection circuit 255. The on/off of the switching circuit 257_A is controlled by the CPU 220. The second register 258_A fetches the value of the first register 256_A, when the switching circuit 257_A is set to “on”, and holds the fetched value while the switching circuit 257_A is set to “off.” In the initial setting, the CPU 220 sets to the third register 260_A an amount of offset control (initial value) which makes small the offset amount of the electrical signal when the optical disk 3 is loaded. The offset controller 259_A determines the amount of offset control based on the value of the second register 258_A and the value of the third register 260_A, shifts the signal level of the electrical signal A based on the determined amount of offset control, and outputs the shifted electrical signal A to the gain circuit 202_A. Specifically, the offset controller 259_A is configured with a DAC etc. which performs resistive subdivision of the inputted electrical signal A, corresponding to the set-up resistance ratio and outputs the subdivided electrical signal. For example, the offset controller 259_A adds the value set to the second register 258_A to the amount of offset control initially set to the third register 260_A, to compensate the amount of offset control. Then, the offset controller 242_A shifts the signal level of the electrical signal by the resistive subdivision ratio corresponding to the amount of offset control after the compensation, and outputs the shifted electrical signal. Accordingly, it becomes possible to perform the offset control of the electrical signals A-H with consideration given to the amount of offset change due to environmental variations.

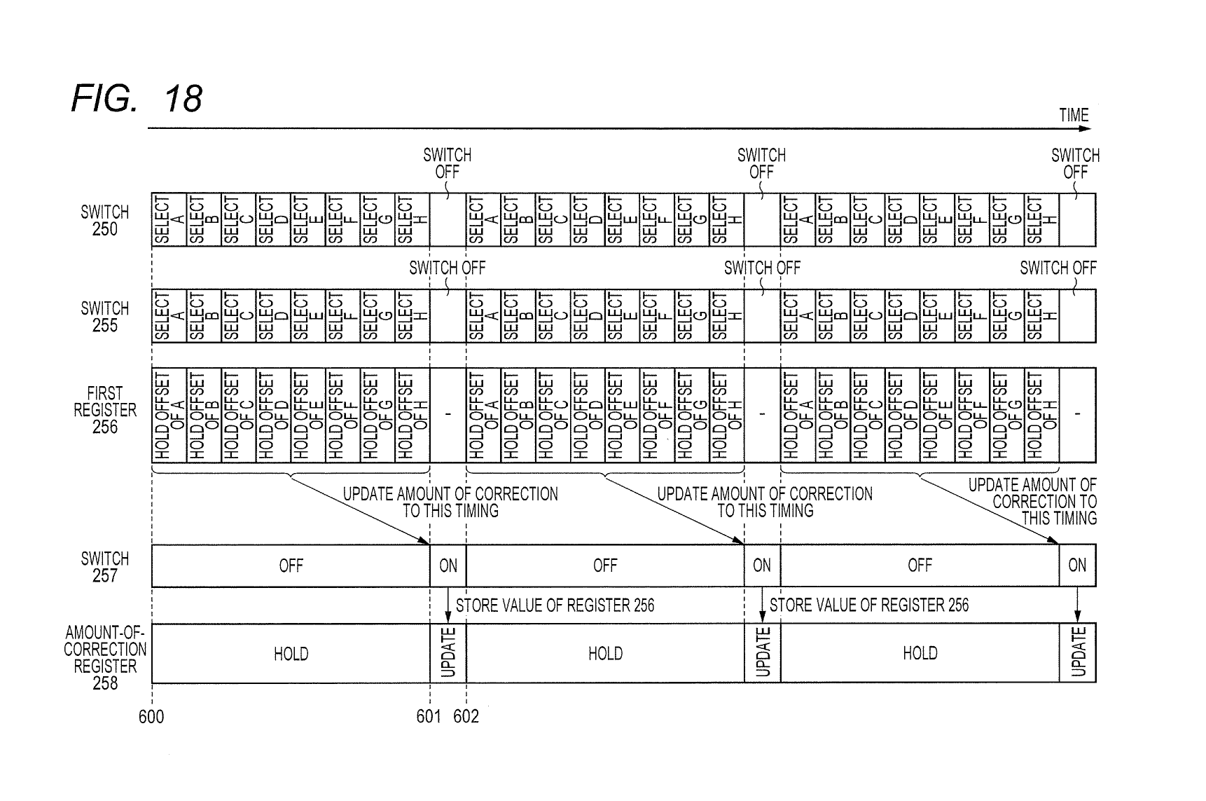

FIG. 18 is a timing chart illustrating an example of timing of the offset control of the electrical signals A-H.

The CPU 220 switches the selection signal of the selection circuit 250 and the selection circuit 255 by time sharing. For example, the CPU 220 instructs the selection circuit 250 to select the electrical signal A at the timing indicated by a reference symbol 600, after that, to select each electrical signal in the order of the electrical signal B, the electrical signal C, . . . , the electrical signal G, and the electrical signal H. Accordingly, the amount of offset change of each electrical signal is detected. The CPU 220 switches the selection signal of the selection circuit 255 in the same order and at the same timing as in the selection circuit 250. Accordingly, the amount of offset change of the electrical signals A-H is sequentially stored in each of the first registers 256_A-256_H of the offset circuits 253_A-253_H. The switching circuits 257_A-257_H are held “off” in the meantime. Then, at the timing 601 at which the amount of offset change has been stored in all the first registers 256_A-256_H, the CPU 220 controls to turn off the switches of the selection circuit 250 and the selection circuit 255 and to turn on all the switching circuits 257_A-257_H. Accordingly, the value of the second register 258 of each of the offset circuits 253_A-253_H is collectively updated, and the offset controllers 259_A-259_H perform the offset control of the corresponding electrical signals A-H based on the updated value. After that, the CPU 220 resumes at the timing 602 the processing to switch the selection signal of the selection circuit 250 and the selection circuit 255 by time sharing. The same processing as the above is repeated subsequently.

As described above, by employing the optical disk device 7 according to Embodiment 4, as is the case with the optical disk device 6 in Embodiment 3, it is possible to perform the offset control taking into consideration the amount of offset change of the electrical signals A-H due to environmental variations, in the stage before generating the signal to be used for the servo control, such as the total signal. Accordingly, it is possible to reduce the offset component without performing the offset control to the signal to be used for the servo control. Therefore, the PE-signal offset circuit 209, the FE-signal offset circuit 212, and the TE-signal offset circuit 215 become unnecessary, and the chip area of the data processing controller 23 can be reduced. The amount of offset change of the digitized electrical signals A-H is detected by time sharing. Therefore, it is not necessary to provide the offset change amount detecting circuit 251 as many as the number of the electrical signals, thereby contributing to reduction of the area of the data processing controller 23.

Furthermore, as is the case with Embodiment 1, it is possible to generate the total signal which is not influenced by environmental variations. Therefore, it is possible to maintain the focus error signal and the tracking error signal at the respective optimal signal levels, irrespective of environmental variations, and it is possible to realize the stable focus servo control and the stable tracking servo control, even in an optical disk which yields a small amount of reflected light. It is further possible to detect the focus servo inability normally, irrespective of environmental variations, by generating the total signal which is not influenced by environmental variations.

As described above, the invention accomplished by the present inventors has been concretely explained based on the embodiments. However, it cannot be overemphasized that the present invention is not restricted to the embodiments, and it can be changed variously in the range which does not deviate from the gist.

For example, in the data processing controllers 20-23 of Embodiments 1 through 4, the location where a signal is digitized by the AD converter 203 is not restricted to the latter stage of the gain circuit 202. It is also preferable that the AD converter 203 may be removed and the signal to be used for the servo control, such as the total signal, may be generated by analog signal processing. In this case, the total signal calculation circuit 204, the focus error signal calculation circuit 205, and the tracking error signal calculation circuit 206 become analog circuits; therefore, it is necessary to consider the amount of offset produced in these arithmetic circuits. For example, in Embodiments 3 and 4, when the arithmetic circuits 204-206 are configured with analog circuits, it is possible to remove the offset component superimposed in the arithmetic circuits 204-206 with a higher degree of accuracy, by providing the PE-signal offset circuit 209, the FE-signal offset circuit 212, and the TE-signal offset circuit 215.

In Embodiment 3, it is also possible to employ the offset change amount detecting circuit 237 in lieu of the offset change amount detecting circuit 207. Accordingly, it is possible to remove the offset component from the total signal with a higher degree of accuracy as is the case with Embodiment 2. In the offset change amount detecting circuit 251 of Embodiment 4, the amount of offset change of the electrical signals A-H may be calculated in consideration of the amplitude value of the electrical signals A-H to be inputted, in the same manner as in the offset change amount detecting circuit 237. According to this, even when the amplitude of the electrical signals A-H changes due to the change of the amount of reflected light, it is possible to remove the offset component of the electrical signals A-H with a higher degree of accuracy.

What is claimed is:

1. An optical disk device for accessing an optical disk, comprising:
an optical pickup operable to irradiate the optical disk with a laser light via an objective lens, to condense the reflected light of the irradiated laser light to light-sensitive surface of a photo detector, and to generate an analog signal corresponding to an amount of the reflected light;
a signal generating unit operable to generate a signal to be used for servo control for controlling the optical pickup so as to control a position of a light spot in the optical disk on the basis of the analog signal;
an offset change amount detector operable to detect an amount of change of an offset amount superimposed on the signal to be used for the servo control;
a signal shaping unit operable to shape the signal to be used for the servo control; and,
a servo control unit operable to perform the servo control on the basis of the signal shaped by the signal shaping unit,
wherein the signal shaping unit compensates an amount of the offset control which has been set up so as to reduce the offset amount in initial setting for light detection corresponding to an optical disk loaded, according to the amount of change of the offset amount detected, and adjusts the signal to be used for the servo control on the basis of the amount of the offset control after the compensation.

2. The optical disk device according to claim 1,
wherein the off set change amount detector calculates a difference between a peak value of the signal detected after completing the initial setting and to be used for the servo control and a peak value of a signal to be used for the servo control, and sets the difference as the amount of change of the offset amount.

3. The optical disk device according to claim 1,
wherein the offset change amount detector calculates an amount of change of a peak value indicative of how much the peak value of the signal to be used for the servo control has changed after the completion of the initial setting, in consideration of a rate of change of amplitude of the signal to be used for the servo control after the completion of the initial setting, and sets the calculated amount of change of the peak value as the amount of change of the offset amount.

4. The optical disk device according to claim 3,
wherein the off set change amount detector calculates a rate of change of an amplitude value of the signal to be used for the servo control after the completion of the initial setting, and multiplies the rate of change by the peak value of the signal detected after the completion of the initial setting and to be used for the servo control, and the offset change amount detector calculates a difference between the multiplied value and the peak value of the signal to be used for the servo control, and sets the difference as the amount of change of the peak value.

5. The optical disk device according to claim 2,
wherein the signal to be used for the servo control includes a total signal corresponding to a summation of the amount of reflected light, a focus error signal for focus servo control, and a tracking error signal for tracking servo control,
wherein the offset change amount detector detects the amount of change of the offset amount of the total signal, and
wherein the signal shaping unit adjusts the total signal through the compensation on the basis of the amount of change of the offset amount of the total signal, and adjusts the magnitude of the focus error signal and the magnitude of the tracking error signal, according to the adjusted total signal.

6. An optical disk device for accessing an optical disk, comprising:
an optical pickup operable to irradiate the optical disk with a laser light via an objective lens, to condense the reflected light of the irradiated laser light to a light-sensitive surface of a plurality of photo detectors, and to generate an analog signal corresponding to an amount of the reflected light for each of the photo detectors;
a signal shaping unit operable to shape the analog signal;
a signal generating unit operable to generate a signal to be used for servo control for controlling the optical pickup so as to control a position of a light spot in the optical disk on the basis of the analog signal shaped by the signal shaping unit;
an offset change amount detector operable to detect an amount of change of an offset amount superimposed on the signal to be used for the servo control; and
a servo control unit operable to control the optical pickup by performing processing for the servo control on the basis of the signal to be used for the servo control,
wherein the signal shaping unit compensates an amount of the offset control which has been set up so as to reduce the amount of offset superimposed on the analog signal in initial setting for light detection corresponding to an optical disk loaded, according to the amount of change of the offset amount detected, and adjusts the analog signal on the basis of the amount of offset control after the compensation.

7. The optical disk device according to claim 6,
wherein the signal to be used for the servo control includes a total signal generated on the basis of a summation of the analog signals corresponding to predetermined photo detectors among the photo detectors,
wherein the offset change amount detector detects the amount of change of the offset amount of the total signal, and
wherein the signal shaping unit calculates the amount of change of the offset amount for each analog signal corresponding to the predetermined photo detector, on the basis of the amount of change of the offset amount of the total signal, and the signal shaping unit adjusts the analog signal on the basis of the amount of change of the offset amount calculated for the each analog signal.

8. The optical disk device according to claim 7,
wherein the analog signal as an adjustment target of the signal shaping unit is selectable.

9. An optical disk device for accessing an optical disk, comprising:
an optical pickup operable to irradiate the optical disk with a laser light via an objective lens, to condense the reflected light of the irradiated laser light to a light-sensitive surface of a plurality of photo detectors, and to generate an analog signal corresponding to an amount of the reflected light for each of the photo detectors;
a signal shaping unit operable to shape an analog signal of the each photo detector;
a signal generating unit operable to generate a signal to be used for servo control for controlling the optical pickup so as to control a position of a light spot in the optical disk on the basis of the analog signal shaped by the signal shaping unit;
an offset change amount detector operable to detect, in a time sharing manner for each photo detector, the amount of change of the offset amount superimposed on an analog signal of each photo detector, shaped by the signal shaping unit; and
a servo control unit operable to perform the servo control on the basis of the signal to be used for the servo control,
wherein in the signal shaping unit, an amount of initial offset control is set up for each photo detector so, as to reduce the offset amount superimposed on the analog signal of each photo detector, in the initial setting of the light detection corresponding to an optical disk loaded, and
wherein the signal shaping unit compensates the amount of initial offset control for each corresponding photo detector according to the amount of change of the offset amount, and adjusts the analog signal concerning the corresponding photo detector, on the basis of the amount of offset control after the compensation.

10. A semiconductor device for controlling an optical pickup and for performing processing to access an optical disk, the semiconductor device comprising:
a signal generating unit operable to input an analog signal generated by the optical pickup corresponding to an amount of reflected light of a laser light irradiated to the optical disk, and operable to generate a signal to be used for servo control for controlling a light spot in the optical disk;
an offset change amount detector operable to detect an amount of change of an offset amount superimposed on the signal to be used for the servo control;
a signal shaping unit operable to shape the signal to be used for the servo control; and,
a servo control unit operable to perform the servo control on the basis of the signal shaped by the signal shaping unit,
wherein the signal shaping unit compensates an amount of the offset control which has been set up so as to reduce the offset amount in initial setting for light detection corresponding to an optical disk loaded, according to the amount of change of the offset amount detected, and adjusts the signal to be used for the servo control on the basis of the amount of the offset control after the compensation.

11. The semiconductor device according to claim 10,
wherein the offset change amount detector calculates a difference between a peak value of the signal detected after completing the initial setting and to be used for the servo control and a peak value of a signal to be used for the servo control, and sets the difference as the amount of change of the offset amount.

12. The semiconductor device according to claim 10,
wherein the offset change amount detector calculates an amount of change of a peak value indicative of how much the peak value of the signal to be used for the servo control has changed after the completion of the initial setting, in consideration of a rate of change of amplitude of the signal to be used for the servo control after the completion of the initial setting, and sets the calculated amount of change of the peak value as the amount of change of the offset amount.
